(19) United States
(12) Patent Application Publication
(10) Pub. No.: US 2005/0108200 A1
(43) Pub. Date: May 19, 2005

(54) Category based, extensible and interactive system for document retrieval

(76) Inventors: Frank Meik, Bad Homburg (DE); Michael Wielsch, Wiesbaden (DE)

Correspondence Address: THE H.T. THAN LAW GROUP, 1010 WISCONSIN AVENUE NW SUITE 580, WASHINGTON, DC, 20007, US

(21) Appl. No.: 10/482,833

(22) PCT Filed: Jul. 4, 2001
(86) PCT No.: PCT/EP01/07649

(51) Int. Cl. G06F 17/30

(52) U.S. Cl. 707/3

(57) ABSTRACT

In information retrieval (IR) systems with high-speed access, especially to search engines applied to the Internet and/or corporate intranet domains for retrieving accessible documents automatic text categorization techniques are used to support the presentation of search query results within high-speed network environments.

An integrated, automatic and open information retrieval system (100) comprises an hybrid method based on linguistic and mathematical approaches for an automatic text categorization. It solves the problems of conventional systems by combining an automatic content recognition technique with a self-learning hierarchical scheme of indexed categories. In response to a word submitted by a requester, said system (100) retrieves documents containing that word, analyzes the documents to determine their word-pair patterns, matches the document patterns to database patterns that are related to topics, and thereby assigns topics to each document. If the retrieved documents are assigned to more than one topic, a list of the document topics is presented to the requester, and the requester designates the relevant topics. The requester is then granted access only to documents assigned to relevant topics. A knowledge database (1408) linking search terms to documents and documents to topics is established and maintained to speed future searches. Additionally, new strategies are presented to deal with different update frequencies of changed Web sites.

### FIELD AND BACKGROUND OF THE INVENTION

The invention generally relates to the field of information retrieval (IR) systems with high-speed access, especially to search engines applied to the Internet and/or corporate intranet domains for retrieving accessible documents using automatic text categorization techniques to support the presentation of search query results within high-speed network environments.

As the volume of published information which can be accessed with the aid of a plurality of corporate networks and particularly via the Internet continues to increase, there is growing interest in helping people better find, filter, and manage these resources. Since said networks represent a young, dynamic and still not much standardized market, they comprise an enormous volume of non-structured documents and text material. Particularly the Internet as an open medium being freely accessible to everyone represents a gigantic knowledge base that is still unused to a great extend, since there are no syntactic rules at all for the retrieval of the stored information.

The insufficient information structure of the Internet (and other networks) is often criticized. Moreover, search engines often fail in coverage or present broken links to publications. What the user would actually like to find can not be found, or the user is strained by a large number of unsuitable matches when receiving the results of an entered search query. Although the desired information possibly is available within these networks, it can not easily be obtained. Simultaneously, the demands for the availability of qualified information rapidly increase both in the commercial and in the private area. Efficient indexing, retrieval and management of digital media is therefore becoming more and more important due to the vast volume of digital information available within the Internet and a plurality of intranet domains.

Manual Indexing of Text Documents

Librarians and other trained professionals have worked for years on manually indexing new items using controlled vocabularies such as in the scope of Medical Subject Headings (MeSH), Dewey Decimal, Yahoo! or CyberPatrol. For instance, Yahoo! currently uses human experts to manually categorize its documents. Likewise, at legal publishing houses such as West Group, legal documents are manually indexed by human experts. This process is very time-consuming and costly, thus limiting its applicability. Consequently, there is an increased interest in developing techniques for automatic text categorization. Rule-based approaches similar to those used in expert systems are common (cf. Hayes and Weinstein's CONSTRUE system for classifying news stories, 1990), but they generally require manual construction of the rules, make rigid binary decisions about category membership, and are typically difficult to modify.

Automatic Text Categorization

The increasing amount of information available in different areas of knowledge creates the need to automate part of the process described above. Automatic indexing algorithms based on statistical patterns of natural language appeared during the 1960's, and 1970's. During the 1980's several systems were created for computer-aided indexing. During the late 1980's several expert systems were applied to create knowledge-based indexing systems, for instance MedIndeEx System at the National Library of Medicine (Humphrey, 1988). The 1990's can be characterized by the advent of the World Wide Web (WWW) which has made available a vast amount of information that is potentially useful. The information overload created by the WWW has stimulated the creation of reliable automatic indexing methods that could help users filter large amounts of documents. Today several researchers around the world are trying to solve the automatic text categorization problem by using two major approaches: firstly, to capture the rules used in human communications and apply them to a system, and secondly, to employ methods for automatically training categorization rules from a training set of already categorized text material. Previous similar works were mainly related to speech recognition, e.g. in the scope of automatic telephone services. For this purpose several topics are predefined, and the recognition system tries to detect the topics from input texts. Once a topic is detected, a statistical model for the text is applied to assist the process of speech recognition.

In general, automatic classification schemes can essentially facilitate the process of categorization. The process of automatic text categorization—the algorithmic analysis and automatic assignment of electronically accessible natural language text documents to a set of prespecified topics (categories or index terms) that concisely describe the content of said documents—is an important component in a plurality of information organization and management tasks. Its most widespread application up to now has been the support of text retrieval, routing and filtering for assigning subject categories to input documents. Automatic text categorization can play an important role in a wide variety of more flexible, dynamic and personalized information management tasks as well.

These tasks comprise:
real-time sorting of emails or other text files into predefined folder hierarchies,
thematic identification to support topic-specific processing operations,
structuring of search and/or browsing techniques, and
finding documents that refer to static, long-term interests or more dynamic, task-based interests.

In any case, classification techniques should be able to support category structures that are very general, commonly accepted, and relatively static like Dewey Decimal or Library of Congress classification systems, Medical Subject Headings (MeSH), or Yahoo!'s topic hierarchy, as well as those that are more dynamic and customized to individual interests or tasks.

### BRIEF DESCRIPTION OF THE PRESENT STATE OF THE ART

According to the state of the art, different solutions to the problem of automatic text categorization are already available, each of them being optimized to a specific application environment. These solutions are based on linguistic and/or mathematical approaches. In order to explain these solutions with regard to said standards, it is necessary to briefly describe the most important conventional techniques of information retrieval, manual indexing and automatic text categorization.

The earliest information retrieval systems were mainframe computers that contained the full text of thousands of documents. They could be accessed from time sharing terminals. The earliest systems of this type, developed in the early 1960's, took a list of words and linearly searched through a tape library of the documents for those documents that contained the specified words.

By the mid to late 1960's, more sophisticated systems first developed word indices or concordances of the searchable words within the set of documents (excluding non-searchable words such as “of”, “the”, and “and”). The concordance contained, for each word, the document numbers of all the documents that contained the word. In some systems, this document number was accompanied by the number of times the word appeared in the corresponding document to serve as a crude measure of the relevance of each word to each document. Such systems simply required the requester to type in a list of words, and the system then computed and assigned a relevance to each document, retrieving and displaying the documents to the requester in relevance order. An example of such a system was the QuicLaw system developed by Hugh Lawford at Queens University in Canada with support from IBM Canada. Phrase searches on that system were done by examining the documents and scanning them for phrases after they had been retrieved, and accordingly these phrase searches were slow.

Other systems, such as Mead Data Central's LEXIS system developed by Jerome Rubin and Edward Gotsman and others, included in its concordance an entry for each word, which included, along with the document number (of the document that contained the word), a document segment number identifying the segment of the document in which the word appeared and also a word position number identifying where, within the segment, the word appeared relative to other words.

West Group's WESTLAW system, developed a few years later by William Voedisch and others, improved upon this by including in the concordance entry for each word
a paragraph number (indicating where the word appeared within the segment),
a sentence number (indicating where the word appeared within the paragraph), and
a word position number (indicating where the word appeared within the sentence).

These two systems, which are still in use today, both permit the logical connectors or operators AND, OR, AND NOT, w/seg (within the same segment), w/p (within the same paragraph), w/s (within the same sentence), w/4 (within 4 words of each other), and pre/4 (preceding by 4 words) to be used for writing formal, complex search requests. Parenthesis permit one to control the order of execution of these logical operations.

Another class of systems, and in particular the dialog system which is still in use today, grew out of the early NASA RECON system that assigned names to previously-performed searches so that those searches could be incorporated by reference into later-performed searches.

Professional librarians and legal researchers use all three of these systems regularly. However, these experts must train for many weeks and months to learn how to formulate complex queries containing parenthesis and logical operators. Lay searchers can not use these powerful systems with the same degree of success because they are not trained in the proper use of operators and parenthesis and do not know how to formulate search queries. These systems also have other undesirable properties. When asked to search for multiple words and phrases conjoined by OR, these systems tend to recall far too many unwanted documents—their precision is poor. Precision can be improved by the addition of AND operators and word proximity operators to a search request, but then relevant documents tend to be missed, and accordingly the recall rate of these systems suffers. To enable untrained searchers to use these systems, various artificial intelligence schemes have been developed which, like the early QuicLaw system, simply permit a requester to type in a list of words or a sentence, and then produce some ranking and production of the documents. These systems produce variable results and are not particularly reliable. Some ask the requester to select a particularly relevant document, and then, using the words which that document contains, these systems attempt to find similar documents, again with rather mixed results.

The WESTLAW system also contains some formal indexing of its documents, with each document assigned to a topic and, within each topic, to a key number that corresponds to a position within an outline of the topic. But this indexing can only be used when each document has been hand-indexed by a skilled indexer. New documents added to the WESTLAW system must also be manually indexed. Other systems provide each document with a segment or field that contains words and/or phrases that help to identify and characterize the document, but again this indexing must be done manually, and the retrieval systems treat these words and phrases in the same manner as they do other words and phrases in the document. With the development of the Internet, Web crawlers have been developed that search the Web creating what amount to concordances of thousands of Web pages, indexing documents by their URLs (Uniform Resource Locators or Web addresses) as well as by the words and phrases that they contain and also by index terms optionally placed into a special field of each document by the document's authors.

Theoretical Background of Machine Learning Techniques

Machine learning algorithms have proven to be very successful in solving many problems, for example, the best results in speech recognition have been obtained with such algorithms. These algorithms learn by performing a search on the space of the problem to be solved. Two kinds of machine learning algorithms have been developed: supervised learning, and unsupervised learning. Supervised learning algorithms operate by learning the objective function from a set of training examples and then applying the learned function to the target set. Unsupervised learning operates by trying to find useful relations between the elements of the target set.

Automatic text categorization can be characterized as a supervised learning problem. First of all, a set of exemplary documents has to be correctly categorized by human indexers. This set is then used to train a classifier based on a machine learning algorithm. Said trained classifier can later on be used to categorize the target set.

Conventional document categorization techniques pursue different approaches. Generally, two different approach alignments can be distinguished. On the one hand many solution experiments for an automatic document categorization are based on rather linguistic approaches. On the other hand the proponents of mathematical and statistical approaches claim that these approaches also yield good results.

Different machine learning algorithms such as decision trees (Moulinier, 1997), neural networks (Weiner et al., 1995), linear classifiers (Lewis et al., 1996), k-Nearest Neighbor algorithms (Yang, 1999), Support Vector Machines (Joachims, 1997), and Naïve Bayes classifiers (Lewis and Ringuette, 1994; McCallum et al., 1998) have been explored to build text categorization systems. Most of these studies build classifiers without regard of the hierarchical structure of the indexing vocabulary. Recently some authors (Koller and Sahami, 1997; McCallum et al. 1998; Mladenic, 1998) have started to explore and use the hierarchical structure of the indexing vocabulary.

Automatic Content Recognition by Means of Grammatical Structures (Linguistic Approach)

Text categorization systems usually try to extract the content of documents to be analyzed by means of a recognition of grammatical structures, that means sentences or parts thereof (for example by additionally applying mathematical approaches like decision trees, Maximum Entropy Modeling or the perceptron model of neural networks). Thereby, the individual parts of a sentence are separated and finally the core statement of the sentence is determined. If the core statement of all sentences of a document was successfully determined, the content of the document can be recognized with a high probability and assigned to a specific category.

Before such a procedure can successfully be used, the inventors and programmers of these procedures must have thought about which word combinations refer to specific topics. Since this is mainly the task of linguists, these procedures are called linguistically based procedures. They normally tend to employ very complex algorithms and to make high demands on technical resources (e.g. concerning processor performance and storage capacity). Nevertheless, the contents-related categorization of a document and thereby the assignment to a category can only be managed with average success.

Automatic Content Recognition by Means of Statistical Techniques (Mathematical Approach)

Mathematical approaches for solving automatic recognition problems usually apply statistical techniques and models (e.g. Bayesian models, neural networks). They rely on the statistical evaluation of the probability of alphanumeric characters and/or combinations thereof, called “strings”. Theoretically, it is assumed that documents which refer to a specific topic can be distinguished by determining the existence of specific strings. After having investigated which strings frequently occur in connection with specific topics, it can be recognized which topic is dealt within a specific document. However, said statistical approaches require that it was previously recognized which strings frequency refer to a specific topic. Therefore, for this approach a large number of documents is required which must be analyzed and evaluated. Previously, each document which has to be analyzed must have been clearly assigned to one or more topics (e.g. by archivists or other authorities). Then, the particular features of these documents (that means the frequency of specific alphanumeric character combinations) are analyzed and stored. After that, for each desired category a so-called “extract” is created and permanently stored within a database. When the system has learned that specific alphanumeric character combinations belong to a specific topic with a high probability, new documents can be compared with said extracts. If a new document shows similarities to one of the stored extracts (i.e. a similar frequency distribution of specific strings), the probability is high that the new document belongs to the same category.

The above-described strategy of applying inductive learning techniques for automatically creating classifiers which use labeled training data is frequently applied. Text classification poses many challenges for inductive learning methods since there can be millions of word features. The resulting classifiers, however, have many advantages: they are easy to construct and update, they depend only on information that is easy to provide (that means examples of items that are in or out of categories), they can be customized to specific categories of interest to individuals, and they allow users to smoothly weigh up precision and recall depending on their task. A growing number of statistical classification and machine learning techniques have been applied to text categorization, including multivariate regression models (Fuhr et al., 1991; Yang and Chute, 1994; Schütze et al., 1995), k-Nearest Neighbor classifiers (Yang, 1994), probabilistic Bayesian models (Lewis and Ringuette, 1994), decision trees (Lewis and Ringuette, 1994), neural networks (Wiener et al., 1995; Schütze et al., 1995), and symbolic rule learning (Apte et al., 1994; Cohen and Singer, 1996). More recently, Joachims (1998) has explored the use of Support Vector Machines (SVMs) for text classification with promising results.

A classifier is a function that maps an input feature vector, x:=(x₁, . . . , xₙ)^{T}εIRⁿ, to a confidence, fₖ(x), from which can be derived if the input feature vector x belongs to a specific class cₖ of a set, C:={cₖ|k=1, . . . , K}, consisting of K classes. In the case of text classification, the features are words in the document and the classes correspond to text categories. In the case of decision trees and Bayesian networks the employed classifiers are probabilistic in the sense that fₖ(x) is a probability distribution.

Fundamentally, a large number of techniques requires that categorizing must be learned first by extracting features from known (that means already thematically categorized) documents. Thereby, it differs in each case which features are preferred and how a similarity calculation is performed. In general, a pre-clustering of documents and a k-Nearest Neighbor (k-NN) classification are performed for this purpose. In the literature, most of the automatic text categorization works are based on several famous text data sets, such as the OHSUMED data set, the REUTERS-21578 data set, and the TREC-AP data set. In these data sets, text units were labeled with topics or categories by trained experts, and therefore the categorization design is fixed. Major research is done to compare different classification machines. For example, these machines can be compared by training and testing different classification machines on the same training and testing set.

The main object of conventional classification schemes is to train the employed classifiers with the aid of inductive learning methods like decision trees, Bayesian networks and Support Vector Machines (SVM). They can be used to support flexible, dynamic, and personalized information access and management in a wide variety of tasks. Linear SVMs are particularly promising since they are both very accurate and fast. For all these methods only a small amount of labeled training data (that means examples of items in each category) is needed as input. This training data is used to “train” parameters of the classification model. In the testing or evaluation phase, the effectiveness of the model is tested on previously unseen instances. Inductively trained classifiers are easy to construct and update and facilitate customizing of category definitions, which is important for some applications.

Each document is represented in the form of a feature vector, x:=(x₁, . . . , xₙ)^{T}εIRⁿ, wherein the components xᵢ (1≦i≦n) of said feature vector represent the words of said document, as typically done in the popular vector representation for information retrieval (Salton & McGill, 1983). For the said learning algorithms, the feature space is reduced substantially, and only binary feature values are used—that means a word either occurs or does not occur in a document. For reasons of both efficiency and efficacy, feature selection is widely used when applying machine learning methods to text categorization. To reduce the number of features, a small number of features based on their affiliation to specific categories is selected. Yang and Pedersen (1997) compare a number of methods for feature selection. These features are used as input to the various inductive learning algorithms as mentioned above.

Conventional Approaches for Performing an Efficient Feature Selection

Automatic text categorization mainly includes two aspects: the category design and the classifier design, which are tightly associated. In general, the performance of statistical classifiers depends on the inherent capacity of the machine itself, as well as the feature selection and the feature vector distribution of the categories defined. In other words, if a more coherent distribution of the feature vectors within each category can be achieved by means of the categorization design, it is much easier for a simple classifier to obtain a satisfactory classification accuracy.

As described above, automatic text categorization is mainly a classification problem. Words and/or word combinations occurring in the document sets become variables or features for the classification problem. A set consisting of documents with a relatively moderate size could easily have a vocabulary of tens of thousands of distinct words. The size of the document feature vector x is usually too large to be useful in order to train a machine learning algorithm. Many of the existing algorithms simply would not work with this huge number of attributes. Therefore, efficient feature selection methods based on document frequency, mutual information, or information gain must be used to reduce the number of words. However, if the number of words to be considered has been reduced too much, crucial information for the categorization tasks might be lost. Normally, the number of words after feature selection could be still in the range of a few thousand words. There are several classification schemes that can be potentially used for text categorization. However, many of these existing schemes do not work well in the text categorization task due to the problems mentioned above.

Performance and training time of many machine learning algorithms are closely related to the quality of the features used to represent the problem. In previous work (Ruiz and Srinivasan, 1998), a frequency-based method is employed to reduce the number of terms. The number of terms or features, is an important factor that affects the convergence and training time of most machine learning algorithms. For this reason it is important to reduce the set of terms to an optimal subset that achieves the best performance.

Two approaches for feature selection have been presented in the literature: the filter approach, and the wrapper approach (Liu & Motoda, 1998). The wrapper approach attempts to identify the best feature subset to use with a particular algorithm. For example, for a neural network the wrapper approach selects an initial subset and measures the performance of the network; then it generates an “improved set of features” and measures the performance of the network using this set. This process is repeated until it reaches a termination condition (either the improvement is below a predetermined value or the process has been repeated for a predefined number of iterations). The final set of features is then selected as the “best set”. The filter approach, which is more commonly used, attempts to assess the merits of the feature set from the data alone irrespective of the particular learning algorithm. The filtering approach selects a set of features using a ranking criterion, based on the training data.

Once the feature set for the training set has been identified, the training process takes place by presenting each example (represented by its set of features) and letting the algorithm adjust its internal representation of the knowledge contained in the training set. After a pass of the whole training set, which is called an epoch, the algorithm checks whether it has reached its training goal. Some algorithms such as Bayesian learning algorithms need only a single epoch; others such as neural networks need multiple epochs to convert.

The trained classifier is now ready to be used for categorizing a new document. The classifier is typically tested on a set of documents that is distinct from the training set.

In the following, the most frequently used mathematical approaches for solving classification problems as given by automatic text categorization shall representatively be summarized.
The perceptron model: A perceptron is a type of a neural network that takes a feature vector of real-valued inputs, x:=(x₁, . . . , xₙ)^{T}εIRⁿ computes a linear combination of these inputs, and produces a single output value f(x). This output f(x) is computed as an inner product of the following form:

$$f ( \underline{x} ) := \{ \begin{matrix}1 , & if {\underline{w}}^{T} \underline{x} + θ = {\sum }_{i = 1}^{n} {w}_{i} \cdot {x}_{i} + θ > 0 \\ 0 , & otherwise\end{matrix}$$
wherein w:=(w₁, . . . , wₙₙ)^{T}εIRⁿ is a real-valued weighting vector, and θ is a threshold that must be surpassed by the weighted combination of inputs in order to set the f(x) to 1. Thereby, the perceptron model represents a trained system that decides whether an input pattern belongs to one of two classes. The learning process of the perceptron model involves choosing the best values of wᵢ (for 1≦i≦n) and θ based on the underlying set of training examples. Geometrically speaking, in two dimensions, these two classes can be separated by a line. Therefore, perceptrons have the limitation that they can only be trained for classification problems that are linearly separable. Modern neural networks are descendants of the perceptron model and the Least Mean Square (LMS) learning systems of the 1950's and 1960's. The perceptron model and its training procedure was presented for first time by Rosemblatt (1962), and the current version of LMS is due to Widrow and Hoff (1960). Minsky and Papert (1969) proved that many problems are not linearly separable and that in consequence the perceptrons and linear discriminant methods are not able to solve them. This work had a significant influence in discouraging research in neural networks. For example, Rumelhart, Hinton and Williams (1986) presented the backpropagation learning procedure using multilayer neural networks.
Decision tree classification: Decision trees are employed to classify instances by sorting them down the tree from the root node to some leaf node, which provides the classification of the instance. Each node in the tree specifies a test of some attributes of the instance, and each branch descending from that node corresponds to one of the possible values for this attribute. An instance is classified by starting at the root node of the decision tree, testing the attribute specified by this node, then moving down the tree branch corresponding to the value of the attribute. This process is then repeated at the node on this branch and so on until a leaf node is reached. Widely used decision tree induction algorithms like C4.5 or rule induction algorithms such as C4.5rules and RIPPER employ decision trees that can be obtained by means of a recursive splitting algorithm do not work well if the number of distinguishing features is large.
Naïve Bayes classification: The Naïve Bayes classifier is a mechanism which is used to minimize the classification error. It can be created by using the training data to estimate the probability of each category cₖ (for 1≦k≦K) given the document feature values xᵢ (with 1≦i≦n) of a new document feature vector x. For this purpose Bayes' theorem is applied in order to estimate the desired a posteriori (conditional) probabilities P(cₖ|x) given by

$$P ( {c}_{k} \vert \underline{x} ) = \frac{P ( \underline{x} \vert {c}_{k} ) \cdot P ( {c}_{k} )}{P ( \underline{x} )} .$$
Since P(cₖ|x) is often impractical to compute, it can approximately be assumed that the feature values xᵢ are conditionally independent. This simplifies the computations yielding:

$$P ( {c}_{k} \vert \underline{x} ) = \frac{P ( \underline{x} \vert {c}_{k} ) \cdot P ( {c}_{k} )}{P ( \underline{x} )} = P ( {c}_{k} ) \cdot {\prod }_{i = 1}^{n} \frac{P ( {x}_{i} \vert {c}_{k} )}{P ( {x}_{i} )} ,$$

wherein the variables employed in the formula above are defined as follows:

| | |
|---|---|
| cₖ: | predefined class or category represented by a set |
| | of reference vectors which can be characterized by |
| | its mean vector mₖ and its covariance matrix Cₖ |
| | (with k ∈ {1, . . . , K}), |
| x: | feature vector for a specific document (x ∈ IRⁿ), |
| xᵢ: | i^{th} component of the feature vector x (1 ≦ i ≦ n), |
| P(x): | a-priori (unconditional) probability for the |
| | feature vector x, |
| P(xᵢ): | a-priori (unconditional) probability for the |
| | i^{th} component of the feature vector x, |
| P(cₖ): | a-priori (unconditional) probability for the |
| | class cₖ, |
| P(x\|cₖ): | a-posteriori (conditional) probability for the |
| | feature vector x on the condition that said |
| | feature vector x can be assigned to the class cₖ, |
| P(xᵢ\|cₖ): | a-posteriori (conditional) probability for the |
| | i^{th} component of the feature vector x on the |
| | condition that said component xᵢ can be assigned |
| | to the class cₖ, and |
| P(cₖ\|x): | a-posteriori (conditional) probability for the |
| | class cₖ on the condition that the feature vector |
| | x can be assigned to said class cₖ. |

Even though Naïve Bayes classification techniques, such as Rainbow, are commonly used in text categorization, said independence assumption severely limits their applicability.

For a set of K classes, C:={cₖ|k=1, . . . , K}, the decision rule which is needed for a classification is then given by
xεcₖ, if P(cₖ|x)>P(cⱼ|x)∀jε{1, . . . , K}Λj≠k,
wherein the feature vector x is assigned to the class cₖ with the maximum a posteriori (conditional) probability P(cₖ|x)
Nearest Neighbor classification: If a single reference vector zₖ is applied for each document class cₖ (for 1≦k≦K) the distribution of the data representing a specific document class cₖ can not precisely be described. A better representation of the data distribution within different classes can be achieved if a large number of prespecified reference vectors z_{r,k} (for 1≦r≦R and 1≦k≦K) with known class affiliation is available. In this case, an unknown feature vector x can be classified by searching for the nearest neighbor among the stored reference vectors z_{r,k}, that means the specific reference vector z_{r,k} having the smallest distance to the unknown feature vector x. For a set of K classes, C:={cₖ|k=1, . . . , K}, the decision rule which is needed for a classification is then given by
xεcₖ, if ρₖ(x)<ρⱼ(x)∀jε{1, . . . , K}Λj≠k,
wherein

$${ρ}_{k}^{2} ( \underline{x} ) := {min}_{r} [ {( \underline{x} - {\underline{z}}_{r , k} )}^{T} ( \underline{x} - {\underline{z}}_{r , k} ) ] , with r ∈ \{ 1 , … , R \} ,$$
is the square Euclidian distance to all reference vectors z_{r,k} of the class Ck. This distance measure leads to piecewise linear separation functions, whereby a complicated division of the n-dimensional data space can be achieved.
k-Nearest Neighbor classification: An instance-based learning algorithm that has shown to be very effective for a variety of problem domains is the k-Nearest Neighbor (k-NN) classification. This algorithm has also been used in text classification. The key element of this scheme is the availability of a similarity measure that is capable of identifying neighbors of a particular document. A major disadvantage of the similarity measure used in k-NN is that it uses all features in computing distances. In many document data sets only a smaller number of the total vocabulary may be useful in categorizing documents. A possible approach to overcome this problem is to adapt weights for different features (or words in document data sets). In this approach, each feature has a weight associated with it. A higher weight for a feature implies that this feature is more important in the classification task. When the weights are either 0 or 1, this approach becomes the same as the feature selection.

A k-NN classification algorithm that uses the Modified Value Difference Metric (MVDM) to determine the importance of categorical features is PEBLS. Therein, the distance between different data points is determined by the MVDM. The distance between two documents represented by their feature vectors, xᵢ and xⱼ (with i≠j), is measured according to the class distribution of these feature vectors. According to the MVDM, the distance between xᵢ and xⱼ is small if they occur with a similar relative frequency in many different classes. It is large if they occur with a different relative frequency in many different classes. The distance between two feature vectors is calculated by the squared sum of individual feature value distances determined by the MVDM. PEBLS can be used in document data sets by considering each word to be either present or absent in a document. A major problem with PEBLS is that it computes the importance of a feature independent of all the other features. Hence, like the Naïve Bayes classification techniques, it is unable to take interactions among different features into account. VSM is another k-NN classification algorithm that learns the feature weight using conjugate gradient optimization. Unlike PEBLS, VSM improves the weight in each iteration according to an optimization function. This algorithm is specifically developed for applying the Euclidean distance measure. A potential problem of this approach is caused by the fact that the k-Nearest Neighbor classification problem is not linear (that means its optimization function is not a quadratic function). Hence, a conjugate gradient optimization in this type of problem does not necessarily converge to the global minimum if the optimization function has multiple local minima.

Another classification algorithm that that is based on the k-NN classification paradigm is the Weight Adjusted k-Nearest Neighbor (WAKNN) classification. In WAKNN, the weights of features are trained using an iterative algorithm. In the weight adjustment step, the weight of each feature is perturbed in small steps to see if the change improves the classification objective function. The feature with the most improvement in the objective function is identified and the corresponding weight is updated. The feature weights are used in the similarity measure computation such that important features contribute more in the similarity measure. Experiments on several real life document data sets show the promise of WAKNN, as it exceeds the performance of conventional classification algorithms according to the present state of the art such as C4.5, RIPPER, Rainbow, PEBLS, and VSM.

Hierarchical Models

Vocabularies such as MeSH have associated relations that organize them in a hierarchical structure using a parent-child relation or a narrower term relation. These relations are built in the vocabulary to facilitate its organization and to help indexers. Except for few works most researchers in automatic text categorization have ignored these relations. Since the arrangement of terms in a hierarchical tree reflects the conceptual structure of the domain, machine learning algorithms could take advantage of it and improve their performance.

Indexing a document is a task wherein multiple categories are assigned to a single document. Although human indexers are effective in this, it is quite challenging for a machine learning algorithm. Some algorithms even make simplifying assumptions that the categorization task is binary and that a document can not belong to more than one category. For example, the Naïve Bayesian learning approach assumes that a document belongs to a single category. This problem can be solved by building a single classifier for each category, in such a way that the learning algorithm learns to recognize whether or not a particular term (category) should be assigned to a document. This transforms a multiple category assignment problem into a multiple binary decision problem.

### DEFICIENCIES AND DISADVANTAGES OF THE KNOWN SOLUTIONS OF THE PRESENT STATE OF THE ART

As mentioned above, each of the applied information retrieval techniques is optimized to a specific purpose, and thus contains certain limitations.

Conventional search engines retrieve thousands of documents containing a word or phrase and do not assist the requester in sorting through all the documents that are captured. In other words, their precision is poor. And the introduction of the AND operator to these systems causes their recall to suffer. All of these systems suffer from an even more fundamental defect: They do not teach the requester how to search other than to the extent that the requester accidentally encounters new words and phrases while browsing. They also do not suggest, nor automate, the application and the use of indexing to the extent that indexing is available. They do not query the requester, offering the requester alternative ways to proceed. They do not automatically index new documents that have not previously been indexed manually.

Since the applied classification schemes of conventional information retrieval systems are not uniform, this deficit thus leads to a poor satisfaction of the requestor's information needs. The main problems associated with retrieval of theme-based news can be identified as follows:
The Web news corpus suffers from specific constraints, such as a fast update frequency or a transitory nature, as news information is “ephemeral”. In general, news articles are available on the publisher's site only for a short period of time. Thus, a database of references easily becomes invalid. As a result, traditional information retrieval (IR) systems are not optimized to deal with such constraints.
Many Web sites are built dynamically, often exhibiting different information content over time in the same URL. This invalidates any strategy for incremental gathering of news from these Web sites based on their address.
Since each publication has its own scheme of topics, it is also difficult to match the classification topics defined by each publication.
Direct application of common statistical learning methods to automatic text classification raises the problem of non-exclusive classification of news articles. Each article may be classified correctly into several categories, reflecting its heterogeneous nature. However, traditional classifiers are trained with a set of positive and negative examples and typically produce a binary value ignoring the underlying relations between the article and multiple categories.
News clustering, which would provide easy access to articles from different publications about the same content, can be an important improvement. The automatic grouping of articles into the same topic requires very high confidence, as mistakes would be too obvious to readers.

To address the problems presented above it is necessary to integrate a specialized retrieval mechanism and a multiple category classification framework in a global architecture, comprising a data model for information and classification confidence thresholds.

### OBJECT OF THE UNDERLYING INVENTION

In view of the explanations mentioned above it is the primary object of the invention to propose a novel search using an automatic text categorization technique for an information retrieval (IR) system with high-speed access, suitable for searching indexed documents within the Internet or any high-speed corporate network domains, which allows to improve the presentation of search query results within said environments. The required information retrieval (IR) system should comprise the following features:
The information retrieval (IR) system shall be extensible without needing any additional manual indexing.
It must be able to accept broadly formulated queries from a requester.
After a search query has been initiated, it shall enter into a dialogue with the requester to refine and focus the search, using precise indexing, in order to considerably improve the precision of searching, thereby minimizing browse time and false hits without suffering a corresponding reduction in the relevant document recall rate.

This object is achieved by means of the features of the independent patent claims. Advantageous features are defined in the dependent patent claims. Further objects and advantages of the invention are apparent in the detailed description which follows.

### SUMMARY OF THE INVENTION

The information retrieval system according to the underlying invention is basically dedicated to the idea of an automatic document and/or text categorization technique, concerning the question how an arbitrary text (the content of a document in electronic form) can automatically be recognized and assigned to a predefined category. This basic technology can be applied to a plurality of products and within a plurality of different environments. In any case, the idea to facilitate the frequently occurring task of selectively searching for documents that can be accessed via the Internet, which is a very time-consuming procedure due to the plurality of the herein contained documents, and to automatically perform this task in the background is the same—irrespective of the underlying application and its environment.

The proposed solution according to the underlying invention thereby involves the creation of a framework to define services for retrieving, filtering and categorizing documents from the Internet and/or corporate network domains organized in a common category scheme. To achieve this, specialized information retrieval and text classification tools are needed.

Briefly summarized, the present invention is an interactive document retrieval system that is designed to search for documents after receiving a search query from a requestor. It contains a knowledge database that contains at least one data structure which assigns document word patterns to topics. This knowledge database can be derived from an indexed collection of documents. The underlying invention utilizes a query processor that, in response to the receipt of a search query from a requester, searches for and tries to capture documents containing at least one term that is related to the search query. If any documents are captured, the processor analyzes the captured documents to determine their word patterns, and it then categorizes the captured documents by comparing each document's word pattern to the word patterns in the database. When a word pattern of a document is similar to a word pattern in the database, the processor assigns the similar word pattern's related topic to that document. In this manner, each document is assigned to one or several topics. Next, a list of the topics assigned to the categorized documents is presented to the requester, and the requestor is asked to designate at least one topic from the list as a topic that is relevant to the requestor's search. Finally, the requester is granted access to the subset of the captured and categorized documents to which topics designated by the requestor have been assigned. The system may rely on a server connected to the Internet or to an intranet, and the requester may access the system from a personal computer equipped with a Web browser.

To save time, queries once processed are saved along with the list of documents retrieved by those queries and the topics to which they are assigned. Periodic update and maintenance searches are performed to keep the system up-to-date, and analysis and categorization performed during update and maintenance is saved to speed the performance of searches later on. The system may be set up initially and trained by having it analyze a set of documents that have been manually indexed, saving a record of the word patterns of these documents in a word combination table within the knowledge database and relating these word patterns to the topics assigned to each document. These word patterns may be adjacent pairs of searchable words (not including non-searchable words such as articles, prepositions, conjunctions, etc.), wherein at least one of the words in each such pairing frequently occurs within the document.

The main idea of the concept according to the underlying invention is to process the documents of the Internet and the information contained therein by means of a classical, natural language based archive structure. The requester shall no longer be strained by a large number of unsuitable results. Instead, he should interactively be lead towards a suitable set of results with the aid of universally applicable or individually defined archive structures. In the foreground stands an easy and fast operability with a minimum of technical expenditure.

This object can only be achieved by employing two essential functions:
1. The content of the documents must automatically be analyzed, categorized and inserted into the archive structure.
2. The user must intuitively be lead towards the set of the results by means of an interactive query system performed by a novel user surface.

The proposed solution according to the underlying invention represents an integrated, automatic and open information retrieval system, comprising an hybrid method based on linguistic and mathematical approaches for an automatic text categorization.

On the one hand it is possible to meet the requirements of all Internet users by means of the novel Internet archive according to the preferred embodiment of the underlying invention providing desired information in a quick, simple and accurate manner. On the other hand significant advantages arise for the data management within individual companies.

Newly developed analysis tools and categorization techniques form the basis of the system architecture consisting of a framework of substantiated linguistic rules. Thereby, arbitrary data supplies of any size can automatically be analyzed, structured and managed.

The proposed system solves the problems of conventional systems by combining an automatic content recognition technique with a self-learning hierarchical scheme of indexed categories. Nevertheless, it still works fast.

Instead of performing a crude semantic full-text research, the system can be used for thematically analyzing all available documents in a context-sensitive and sensible manner.

An hierarchically structured topical search—which could only be performed in the domain of corporate networks so far for reasons of capacity—can now be extended to the Internet domain. In this way, different intranets and the Internet can grow together towards a conjoint data space with a homogeneous structure.

The information retrieval system according to the preferred embodiment of the underlying invention can flexibly be adapted to the archive structure and the data management of individual companies. Available information supplies can be read in by incorporating already available hierarchical structures, thereby being associated with new information. Vertically organized information chains are thus rebuilt by an horizontally organized archive structure that permits a permanent and decentralized access on needed data supplies and documents.

Thus, a virtual archive of the information and knowledge supplies of an individual enterprise is given which can completely be updated at any time since the information retrieval system according to the preferred embodiment of the underlying invention also serves as an interface between corporate network domains and the Internet. The intern archive structure of an individual company can be applied to all documents stored within the Internet without needing additional expenditure. The system thereby enables an unification of searches in both domains.

### BRIEF DESCRIPTION OF THE CLAIMS

An interactive document retrieval system is designed to search for documents after receiving a search query from a requester. Thereby, said system comprises a knowledge database containing at least one data structure that relates word patterns to topics, and a query processor that, in response to the receipt of a search query from a requester, performs the following steps:
searching for and trying to capture documents containing at least one term related to the search query, if any documents are captured,
analyzing the captured documents to determine their word patterns,
categorizing the captured documents by comparing each document's word pattern to the word patterns in the knowledge database,
and if a document's word pattern is similar to a word pattern in the knowledge database, assigning to that document the similar word pattern's related topic,
presenting at least one list of the topics assigned to the categorized documents to the requester, and
asking the requester to designate at least one topic from the list as a topic that is relevant to the requestor's search, and
granting the requestor access to the subset of captured and categorized documents to which topics designated by the requester have been assigned.

For this purpose an hybrid method based on linguistic and mathematical approaches for an automatic text categorization by means of an automatic content recognition technique along with a self-learning hierarchical scheme of indexed categories can be applied.

### BRIEF DESCRIPTION OF THE DRAWINGS

Further advantages and suitabilities of the underlying invention result from the subordinate claims as well as from the following description of two preferred embodiments of the invention which are depicted in the following drawings:

FIG. 1 is an overview block diagram of an indexed extensible, interactive retrieval system designed in accordance with the principles of the underlying invention;

FIG. 2 illustrates the database that supports the operation of the retrieval system;

FIG. 3 is a flow diagram of the set-up procedure for the retrieval system;

FIG. 4 is a flow diagram of the query processing procedure for the system;

FIG. 5 is a flow diagram of the live search procedure that is executed by the query processing procedure when a new query word is encountered;

FIG. 6 is a flow diagram of the update and maintenance procedure for the system;

FIGS. 7-9 together form a flow diagram of the document analysis procedure;

FIG. 10 is a flow diagram of the document categorizing procedure;

FIG. 11 presents an overview block diagram of the system hardware;

FIG. 12 presents an overview block diagram of the novel search engine according to the preferred embodiment of the underlying invention;

FIG. 13 presents the system architecture of the Internet archive according to the preferred embodiment of the underlying invention and the co-operation of the components applied therein; and

FIG. 14 illustrates the work flows of the Internet archive according to the preferred embodiment of the underlying invention

### DETAILED DESCRIPTION OF THE UNDERLYING INVENTION

The solution according to the underlying invention uses the most effective elements of the above-mentioned techniques and represents an optimized synthesis thereof. The redesigned categorization algorithm is able to analyze and to categorize texts, basing on mathematical and statistical fundamentals in co-operation with linguistic, documentation and data management models that are based on classical or individual archive structures.

Due to recent experiences many linguistic details can be compensated by means of statistical methods, however, without a detailed knowledge of the underlying language the content of a document can not sufficiently be determined. Therefore, the approach according to the preferred embodiment of the underlying invention understands itself as an integrated approach. It performs a contents-related context analysis of the available documents and thematically assigns these documents to previously defined categories.

The Search Engine

The central component of the information retrieval system according to the preferred embodiment of the underlying invention, the novel search engine, performs the above-mentioned document categorization. Herein, all steps are executed for a contents-related classification and categorization of the documents, and the results of this categorization (the so-called “extracts”) are permanently stored in a database:
1. In a first step, the learning or starting phase (Set-Up Mode), the desired categories must be learned by means of the novel search engine. This is done by reading and analyzing of documents which have already been thematically assigned to one or several categories. Thereby, the assignment of the documents can be performed by an individual company (for example if an archive structure is already available) or by trained archivists. The results of said analysis, i.e. the features comprised in a document of a specific category, are permanently stored in a database. They can be read out at any time and thus easily be included in the data security structures of a specific company.
2. After this first step the recognition or production phase (Live Mode) is initiated. The documents which are now supplied to the novel search engine according to the preferred embodiment of the underlying invention—for example in the form of text files, emails, etc.—are then compared to already categorized information (extracts) stored in the database. If a new document shows similarities to the categorized information of an extract, it can be deemed as very likely that the content of said document can be assigned to the category represented by said extract.

In this case it is important to note that in fact only references to already known documents (e.g. the addresses comprising UNC, URL, etc.) are stored, and not the content of the documents. Thereby, the needed memory space can considerably be minimized. On the average, for each document 150 Byte of information needed for categorization are stored in the database. For a network of a company with approximately 6 million documents an additional memory of approximately 860 MByte would be required for the novel search engine according to the preferred embodiment of the underlying invention. This is only one fraction (approximately 5%) of the entire memory space occupied by the documents on the basis of an average document size of 3 kByte. Furthermore, this approach enables the user to keep on storing his document where it is usually stored. Hence, the usual work flows of the company and/or the individual customers are not impaired.

Pre-Categorization of Documents

Although documents can be analyzed very fast with the aid of the novel search engine according to the preferred embodiment of the underlying invention, a pre-categorization of specific documents is performed in order to further improve the reaction times. Each document which the system shall know and sort into specific categories has previously to be read, analyzed and pre-categorized. The biunique identifications of the documents are then filed within a database along with the assigned categories of said documents.

Depending on the size and number of the documents, the time for the pre-categorization varies. Nevertheless, rough standard values can be presented. On a personal computer with an average performance running with the operating system Linux approximately 500,000 documents can be categorized per day. With more efficient computers (e.g. with multi-processor systems) a duplication or even a tripling of this number can be achieved.

Additionally, it is of course important that an access to the documents can be realized for the purpose of reading said documents. Thereby, available and well-proved security structures need not to be changed, and only those documents are stored in the novel search engine that are allowed to be stored therein.

Continuous Updates

The topicality of the categorized inventory of documents is guaranteed by a newly designed updating algorithm. Said updating algorithm contributes to the processing of a daily occurring number of one million modifications of documents and more, and to be essentially up-to-date.

The updating algorithm runs permanently in the background. Modifications of the documents are tested, and a further analysis is initiated if required, so that the categorization is always essentially up-to-date. Thereby, it was considered that an impairment of familiar work flows can be avoided.

Furthermore, the updating algorithm is designed such that a scaling can easily be performed. If the frequency of modifications should not be manageable any more by a single computer due to its limited performance, additional computers can be employed in order to take over parts of the updating process.

Differentiation from Other Systems

The information retrieval system according to the preferred embodiment of the underlying invention differs from products available on the market in several aspects:
The definition of categories can easily and quickly be performed, particularly for individual customers. A pre-categorization is a task that can be finished within a few days. Furthermore, there is a possibility to prepare different exemplary archives with various topical emphases and contents-related alignments.
The on-line text categorization is automatically performed and does not need to be maintained. Analysis tools for the monitoring of the categorization inform about whether the available quality of the results still corresponds to the requirements of the customer and to the present facts. Modifications of the default parameters of the categorization system are possible at little expense and low expenditure. In later versions of this component customizing functions are integrated that enable the customer to individually adapt the novel search engine according to the preferred embodiment of the underlying invention to specific requirements.
An existing categorization can simultaneously have an effect both on the corporate network of a specific company and on the whole Internet. Each document from the Internet is classified and categorized from the perspective of the archive structure which is applied in an individual company. In this way, a comparability of the documents of both domains becomes much simpler.
Compared with other techniques, the adaptation to further languages with the aid of the novel search engine according to the preferred embodiment of the underlying invention involves a significantly lower expenditure.
The technical expenditure for the use of the novel search engine according to the preferred embodiment of the underlying invention within the domain of a company is very low. In many cases already available systems can be applied to the additional tasks of categorization and storage of information.
With the aid of the information retrieval system according to the preferred embodiment of the underlying invention a wide spectrum of operating systems and databases can be supported. Thereby, the achieved flexibility makes it easy for many companies to profitably employ the offered functionality.

Applications of the Information Retrieval System According to the Preferred Embodiment of the Underlying Invention

The information retrieval system according to the preferred embodiment of the underlying invention with its heart, the novel search engine, can easily be employed at different places in the domain of an individual company or, likewise, in the domain of the Internet. In the following, these two important fields of application are briefly described.

1. Application Field Internet

Due to the high performance of the novel search engine according to the preferred embodiment of the underlying invention during the analysis (several millions of documents per day) and the comparatively small memory requirement, the novel search engine is the ideal basis for a structuring of information from the Internet.

A possible field of application is the Internet archive according to the preferred embodiment of the underlying invention. For example 60 million German documents which are accessible via the Internet are categorized and stored along with their category information, thereby using a specially designed novel search engine.

Thereby, the customer can enter search keys with the aid of a novel interactive user interface. Each document from the Internet which contains the desired search key is searched in a classical manner. But in contrast to previous approaches thousands of irrelevant search hits are not consecutively displayed any more. Instead, all search hits are analyzed with the aid of a predefined and commonly approved archive structure. Correspondingly, at first those categories are displayed, in which documents can be retrieved that contain the entered search keys. Thus, the requester is not strained by a large number of results, but can easily select those documents within the offered categories which he is actually searching for.

The above-described field of application is enabled by means of the following features of said Internet archive according to the preferred embodiment of the underlying invention:
Novel search technique: Within said information retrieval system according to the preferred embodiment of the underlying invention a novel, high-performance “crawling and parsing” technique comprising classical search machine functions is employed. This field of application is designed in such a way that the text material provided for the pre-categorization is specially optimized to the needs of the categorization system with regard to quality and speed aspects.
Updating: Due to the large number of Web sites in the Internet the number of the daily changing Web sites is very large. Thereby, up to two million changed Web sites per day have to be considered. In order to cope with this huge amount of data, a specially developed updating function is employed for visiting Web sites dependent on their individual modification cycles and providing them for a further analysis. The updating function implemented in this way runs 24 hours per day and guarantees a maximum topicality of the Internet archive.
Scaling: The architecture of the employed system concerning total performance and accessibility rate to the Internet can easily be scaled with regard to the applied hardware and software, respectively, and also corresponding to the high demands on simultaneous accesses to the Internet. The extendibility of all employed components can quickly and easily be realized.

The Internet archive according to the preferred embodiment of the underlying invention is not an isolated product. Its features can rather be adapted to the special needs of individual companies. Said adaptation is particularly performed on the basis of an individually adapted definition of categories and the sorting into an archive structure. For example, a company can store an already available own archive structure within the novel search engine according to the preferred embodiment of the underlying invention and later on search the Internet with the aid of said archive structure. In this case, the search functionality of the Internet archive according to the preferred embodiment of the underlying invention is employed, whereby an optimal access rate and processing of the results can be guaranteed.

The employees of an individual company can be provided with categorized documents as usual in the domain of said company. Optionally, documents of specific categories can be masked off, other categories can be emphasized (ranking).

2. Application Field Corporate Networks

The capacity of the novel search engine according to the preferred embodiment of the underlying invention can also be employed within the corporate networks or corporate intranets of individual companies. Thereby, the performance of the system is based on the same core technology which enables a contents-related analysis of documents. Compared to the Internet, in corporate networks only the ways over which documents are supplied to the novel search engine according to the preferred embodiment of the underlying invention are different. Herein, the classical search functions which are employed in the Internet domain can usually not be employed, since both the storage types and the file formats considerably differ from those of the documents available in the Internet. For example, the text which has to be processed can not only be found here in the format of HTML files, but also in formats like Microsoft Word, Microsoft PowerPoint, Microsoft RTF, Lotus Ami Pro and WordPerfect, respectively. Additionally, texts can also be found
in databases like ORACLE, Microsoft SQL Server, IBM DB/2, etc.,
in mail or messaging servers (e.g. Lotus Notes, Microsoft Exchange, etc.),
in network disk drives running with UNIX systems, or
in storage partitions of mainframe computers.

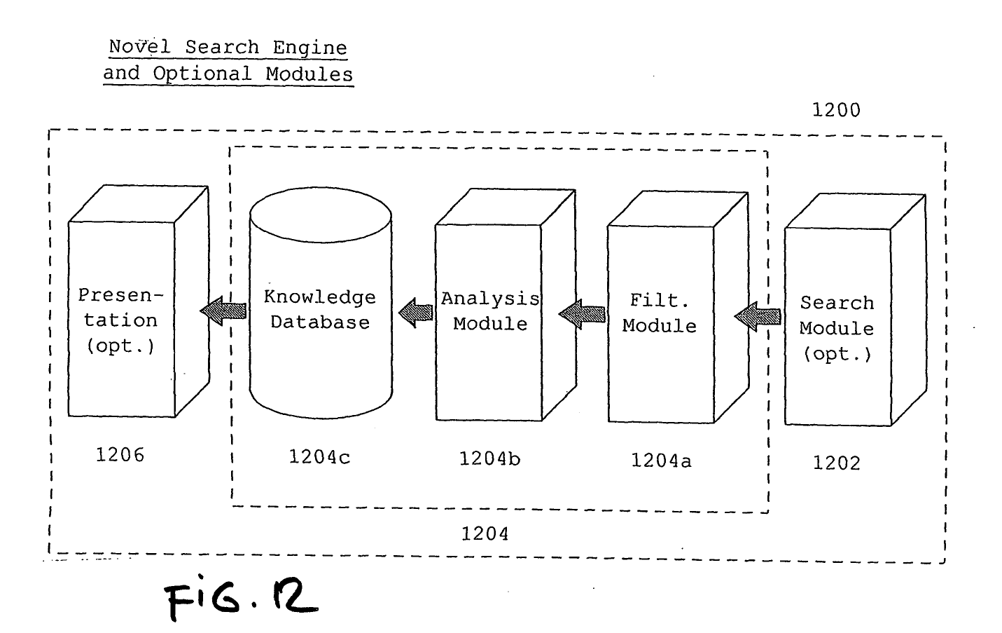

This makes the operation in the domain of corporate networks much more difficult. Nevertheless, the modular architecture of the novel search engine according to the preferred embodiment of the underlying invention is specially equipped for being employed in this field of application. As can be taken from FIG. 12, each document which shall be analyzed, is first submitted to a so-called filtering module. Herein, the actual text is extracted from the document and supplied to an analysis module. This technique makes it possible to determine the specific type of a document (Microsoft Word, Microsoft PowerPoint, Microsoft RTF, Lotus Ami Pro or WordPerfect), and to start the associated filtering module. For this purpose only the supply ways to the novel search engine must be adapted to the available network infrastructure of a specific company. In some cases the most important and most frequently requested documents are stored in a central file server that can be applied from users via network disk drives (in Windows called “shares”, in UNIX called “exported file system”). In other cases important data are stored in databases and/or administered by a document management system.

Irrespective of the specific location of the physical memory and the specific file format there are possibilities to extract the relevant text and to pass it on to the novel search engine according to the preferred embodiment of the underlying invention.

In the domain of corporate networks the representation of the obtained results of a search query can extremely vary. For the Internet solution—the Internet archive according to the preferred embodiment of the underlying invention—a novel user interface was designed and developed. This form of representation does not need to be valid for all companies, even though it was very carefully considered to implement an easy access to the obtained set of results for the above-mentioned user interface.

Nevertheless, there are specific situations, in which the information stored within the database of the novel search engine must be read out and/or presented in a specific way according to the requirements of a specific company. For these situations a simple Application Programming Interface (API) was defined that enables an easy access to the novel search engine according to the preferred embodiment of the underlying invention from arbitrary applications.

System Architecture

The information retrieval system according to the preferred embodiment of the underlying invention can comprise a large number of modules. Three core modules form together the novel search engine. Furthermore, additional optional modules, which can differently be composed according to the customer and the field of application, can be employed.

Performance of the Core Modules

As can be taken from the preceding sections, all central modules are combined within the novel search engine according to the preferred embodiment of the underlying invention. The novel search engine comprises three different modules being separated of each other by properly defined interfaces, and simultaneously being designed for scaling: the filtering module, the analysis module, and the knowledge database.

The Filtering Module

The filtering module represents a frame for the application of text filters, whereby the relevant text can be extracted from a document with a specific intern structure. For example, if an HTML filter is applied, all formatting instructions (HTML tags) are rejected, and the pure text parts of the retrieved document are separated. In many situations it must additionally be identified which of these text parts are relevant for the requester, because many HTML Web sites contain much irrelevant additional information which does not refer to the actual content of said Web site.

Using other document types (e.g. Microsoft Word) requires also to remove the formatting information. Although the relevant content of such file structures can easily be obtained, indeed, it is a question of binary files whose analysis is more extensive.

The filtering module can be implemented by means of the programming language C++, in order to enable a maximum of portability without any loss of performance. The elements which depend on the underlying operating system were shifted into separated classes in order to avoid rearrangements of the source code as far as possible, for example, if the program has to be executed on a different computer.

Furthermore, communication mechanisms between the modules are employed which are used by nearly all operating systems in same form in order to facilitate scaling. Thus, it is possible to start the filtering module on a first computer whereas the other modules of the novel search engine are running on other computers.

Thereby, the novel search engine according to the preferred embodiment of the underlying invention can easily be adapted to the requirements of the user. Originally, the entire search engine can be run on a single computer. If the performance of this computer should not be sufficient any more, an independent computer can easily be employed just for the filtering module in order to perform a high-performance filtering of the retrieved documents.

The Analysis Module

Likewise, a maximum of portability without any loss of performance was considered for the analysis module. All components of the analysis module are written in the programming language C++, whereby the actual recognition algorithm is completely irrespective of the underlying operating system.

Each part of the program which maintains a communication with other modules was separated by means of different classes. In this way, an Inter Process Communication (IPC) can easily be employed instead of using conventional communication mechanisms. The expenditure for the implementation of an IPC is minimal.

Moreover, accesses to the knowledge database according to the preferred embodiment of the underlying invention were properly separated from the analysis module by means of internally defined interfaces. For the task of the analysis module the version of the underlying database is irrelevant. Thereby, only minimal demands were made which can easily be fulfilled by means of conventional databases.

The Knowledge Database

The last one of the core modules, the knowledge database is employed for the permanent storage of category information, and the references to already (topic) known and analyzed documents including the thereto needed connotations. Said knowledge database is a logical data model that can be stored within a large number of database systems.

For the Internet archive according to the preferred embodiment of the underlying invention for example the database system ORACLE (version 8.1.6) can be used since it represents a suited platform for the amounts of data to be processed and the possibly large number of accesses. Besides, the database system ORACLE is equipped with a large number of mechanisms which enables scaling to a great extent. In addition, ORACLE is offered for a large number of operating systems (e.g. SunSoft Solaris, HP-UX, AIX, Linux, Microsoft Windows NT/2000, Novell NetWare, etc.) that are able to communicate with each other and to exchange data.

For the design of the data model for the knowledge database according to the preferred embodiment of the underlying invention it is consciously considered that databases which are already employed within a company can also be used. For example, it is also possible to store the data model within a Microsoft SQL Server (recommended: version 7 and higher versions) without a great expenditure. Alternatively, the application of Informix or DB/2 (developed by IBM) and other databases can also be taken into consideration.

Optional Modules

Aside from these core modules of the novel search engine according to the preferred embodiment of the underlying invention a plurality of optional modules is offered.

According to the respective field of application of the novel search engine it is very different, in which way the documents to be analyzed are retrieved and supplied to the user. For applications in the scope of the Internet available classical search techniques combined with the solution according to the preferred embodiment of the underlying invention are recommended. Alternatively, user specific search techniques can also be employed.

For a search in the scope of corporate networks an agent technique or specially adapted search techniques are suggested. The same applies to the presentation of the results.

Customized User Interfaces

The modular concept pursued during the implementation of the information retrieval system according to the preferred embodiment of the underlying invention is also be achieved for other components. In this way, aside from the central components of the novel search engine according to the preferred embodiment of the underlying invention further optional modules were created. This is for example the user interface, which can easily be adapted to the individual requirements of the customer.

A novel user interface was designed for an Internet application. After the search keys have been entered by the user, said application takes over the control and routes the customer towards the desired result, which is of a much better quality than that of conventional search engines since only those documents are displayed that are relevant for the user. Additionally, the obtained results are categorized. By means of the underlying implementation each document of a selected category is classified according to its origin (public places, media and/or encyclopedias, enterprises or other sources). In this way, a differentiation is offered which is not achieved in any other application.

Since an access on the knowledge database according to the preferred embodiment of the underlying invention is executed with the aid of a fixed interface (which can be defined as a PL/SQL packet or a C++ class, respectively), it is conceivably simple to display these data in a different form. Theoretically, other accesses on the basis of client/server architectures are also imaginable. In this case the information from the database can also be retrieved within Microsoft Access or by means of the programming language Visual Basic.

Additionally, implementations into already available user interfaces within companies are possible. In this way, the data of the knowledge database according to the preferred embodiment of the underlying invention can also be accessed from the individual portal of an enterprise. Thereby, it is irrelevant whether this portal can be operated with the programming languages Java (e.g. JSerylets), VBScript (e.g. Active Server Pages) or PHP (within the Apache Web server) In any case, the data can easily be retrieved.

Document Search and Monitoring

Whereas in the Internet domain the search for documents and/or the monitoring of document changes is already developed to a great extent, it must be stated, however, that for the intranet domain these techniques may be inadequate.

In this case, the term “inadequate” refers to all conventional approaches for the intranet domain that are based on filing documents at a central place within the network. Thereby, these documents can be managed in a much easier way, however, this means additional work and less flexibility for the customer while searching for these documents. Systems based on these approaches severely intervene in the work flows, and require a large number of adaptations. This means, for example, that the available document management software possibly does not co-operate with the employed messaging software (Lotus Notes, Microsoft Exchange, etc.), and thus a uniform search for documents in both systems is not possible at all.

A further problem which is often responsible for the failing of a search request is the great variety of locations and types for the storing of files. For a successful search a uniform mechanism must be available which enables a search even in heterogeneous environments.

It is therefore a further object of the underlying invention to provide the user with all documents and texts that are available in a company (irrespective of location or type for the storing of this data), so that the user does not need to exactly know where a document can be found. As long as said document is stored in the knowledge database, it can easily be retrieved and supplied to the customer provided that it is approved by the security precautions of the individual company he is working for.

Due to the properly defined interfaces to the novel search engine according to the preferred embodiment of the underlying invention a search for the most different types of documents on different platforms can quickly and easily be realized. The basis for this is a so-called framework of interfaces and components, whereby new components can easily be integrated.

Interface to the Internet

With the aid of the integrated search technique introduced in the preceding section, which is available as an optional module, the Internet with its millions of freely accessible documents can easily be moved into the focus of the users. For this purpose those techniques are used that are already employed in the Internet archive according to the preferred embodiment of the underlying invention. On the one hand it concerns components that are already available in a completely programmed and tested version, and on the other hand components that clarify the unifying character of the software applied to the underlying invention.

Provided that a company already has its own archive structure, the structure stored in the novel search engine according to the preferred embodiment of the underlying invention can be extended to documents from the Internet domain without needing an additional programming. If a company should not have an own archive structure yet, it can easily be installed.

In this way, a uniform access to all accessible documents can be achieved, regardless whether they come from the intranet domain of the respective company or from the Internet.

Interface to Professional Databases

Aside from freely available documents and texts from the Internet, that represent a significant advantage due to a better arrangement—provided that they are properly analyzed and categorized, texts can also be received from professional databases; a service which has to be paid. In case of entering a search query by the customer, references to documents stored within these databases can be displayed, aside from the documents retrieved from the intranet or any corporate networks.

For this purpose interfaces have been designed that can be linked into the framework of the document search to read out and categorize freely accessible abstracts of documents retrieved from professional databases. With the aid of this method unnecessary extractions of texts from professional databases (which might be very expensive for an enterprise) can be avoided since it becomes immediately understandable for the customer due to the underlying archive structure whether the found document is suitable or not. The expenditure for the administration of said system is minimal.

The following applications are also possible:
Multilingualism: Multilingualism is the basis for a successful application of the system in the scope of large, worldwide-acting enterprises.
Document search in the domain of corporate networks: As described above, the document search in the domain of corporate networks is much more difficult than in the domain of the Internet. Therefore, analog search techniques for different operating systems, networks and databases are necessary.
Filtering means for reading further data sources: For an adequate processing of documents in the domain of corporate networks additional data filters for reading further data sources are needed. There is also a demand for filters, that can be integrated into the filtering module (e.g. for the enabling of an access on Microsoft Exchange or Lotus Notes).

Customized product adaptations
Customizing: According to specific requirements of the user, customized applications must be developed and designed. For example, they allow to individually adapt the search engine to the specific requirements of the customer, as far this is possible in a standardized manner.
Security structures: Normally, each enterprise has its own security structures for its documents. Thereby, it is the object, to integrate the system into the existing security structures. Very important is also the co-operation with existing services, as e.g. Microsoft Active Directory, Novell NDS and other X.500 based services.
Concept of the logical data space: The specific features of documents and/or data sources and their security requirements are reasonably summarized by the concept of the logical data space. A data space is a set of logically connected documents. Thereby, the user shall be provided with a plurality of such data spaces. The administrator has then the possibility to individually open or close these data spaces. For this purpose the concept of said data space has to be completely developed and implemented.
Exemplary archives: Since a plurality of customers does not have an own archive yet, it would be very important to access on predefined exemplary archives. Thereby, high implementation costs could be saved for the customer. Nevertheless, the customer shall be able to carry out individual adaptations by himself.

A series of supplementary products can be developed and produced. It is the object to provide the user with the capacities of the novel search engine according to the underlying invention over a large number of media and, simultaneously, enabling an homogeneously structured access on arbitrary forms of texts.
Mobile applications: The features of the Internet archive according to the preferred embodiment of the underlying invention can easily be integrated into mobile applications. Thereby, it is planned to make the input of search keys and the display of search results also available for mobile telephone devices and Digital Personal Assistants (PDAs). This means that a man-machine interface must be developed that is capable of applying the WAP standard. Likewise, inputs of customers using mobile applications according to the UMTS standard must be received, and corresponding answers must be returned. Due to the large bandwidth supplied by UMTS a graphical user interface can be applied.
Personalization: The user interface and also further elements of the information retrieval system shall be further adapted to the requirements of the customer. In this way, an emphasis on search results from specific fields is conceivable, aside from a specific design of the user interface. Each customer shall have the possibility to adapt the information retrieval system to specific requirements to achieve the effect of a better identification with the system. In this way, a higher acceptance of the system can be achieved.
Automatic voice recognition: Within the next years the demand for a program control by means of a voice data input will rise. Therefore, it is necessary to initiate search queries by means of voice commands that have to be automatically recognized and interpreted. Additionally, search results shall also be presented by means of a voice data output. The novel search engine according to the preferred embodiment of the underlying invention is then controlled by means of an automatic voice recognition application.
Agent techniques: Along with further customizing, new search techniques shall be supplied to the user. For example, search queries shall be passed on programs (called “agents”) which continuously process a search query in the background. These programs present obtained results not until the search is finished. Alternatively, programs can be developed that react to the occurrence of specific events within the Internet and/or corporate networks.

### DETAILED DESCRIPTION OF THE PREFERRED EMBODIMENT

A fundamental concept underlying the present invention is having it function as if the requester were talking to another human being, rather than to a machine. The requester asks a question by entering a search term. The retrieval system then responds, as a human might, with a question of its own that prompts the requestor to select one from several suggested topics (or subjects or themes) to narrow and focus the search, improving search precision without a commensurate drop in recall. Through one or more such questions and answers, the requester is enabled to narrow the scope of the search to a small, indexed subset of all the documents that contain the search term that the requestor provided.

The system thus tries to eliminate semantic ambiguities by narrowing down the search through dialogue and through the use of indexing of the documents. The indexing, being relatively precise, greatly improves precision by blocking the retrieval of documents that use the search term in semantically different ways than those intended by the requester. But since only documents containing semantically different meanings of the search term are blocked from retrieval, the recall performance of the system remains relatively unimpaired.

As an example, if the requester enters the search term “golf” into the system, the requester will be presented with a list of topics that are related to the search term “golf” in differing ways (e.g. “Cars”, “Sports”, “Geography”, etc.). If the requester chooses the topic “Cars”, he or she will then be presented with a list of subtopics (e.g. “Buy and Sell Cars”, “Technical Specifications”, “Car Repair”, etc.) and must make another choice of a subtopic. Finally, the requester is presented with a set of documents that are closely related to the selected topics as well as to the search term.

At the center of this approach is the concept of having every document analyzed and categorized, preferably ahead of time, into a hierarchical scheme of topics or index categories. The topics are incorporated into the system when it is first set up and again whenever a new document is found and categorized. This process of assigning documents to topics is called knowledge development. It must be done once manually as a system set-up activity. Over time, search terms are saved along with the documents to which they are linked, and tables are constructed that indicate the indexing of these documents. Whenever an entirely new search term is supplied by the requester, an unindexed search within the domain of the Internet or an intranet is performed, and the new documents found are then automatically analyzed for word and phrase content, compared to the word and phrase content of the indexed documents already present within the system (categorization), and then incorporated into the indexed database for future reference. The system thus learns as it receives new questions and encounters new documents. Thereby, the system expands its indexed knowledge base over time, giving improved performance as the system is exercised.

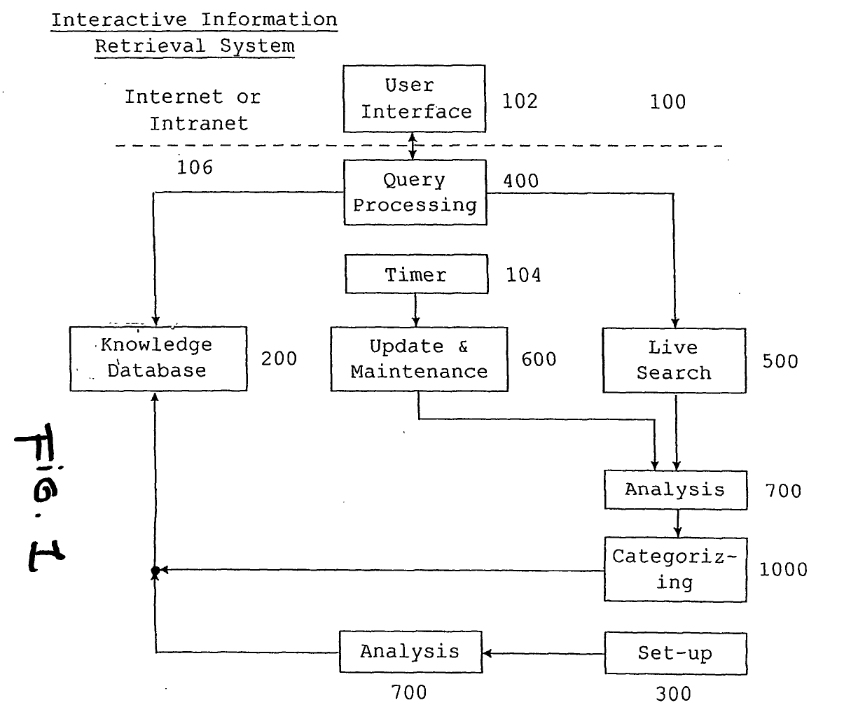

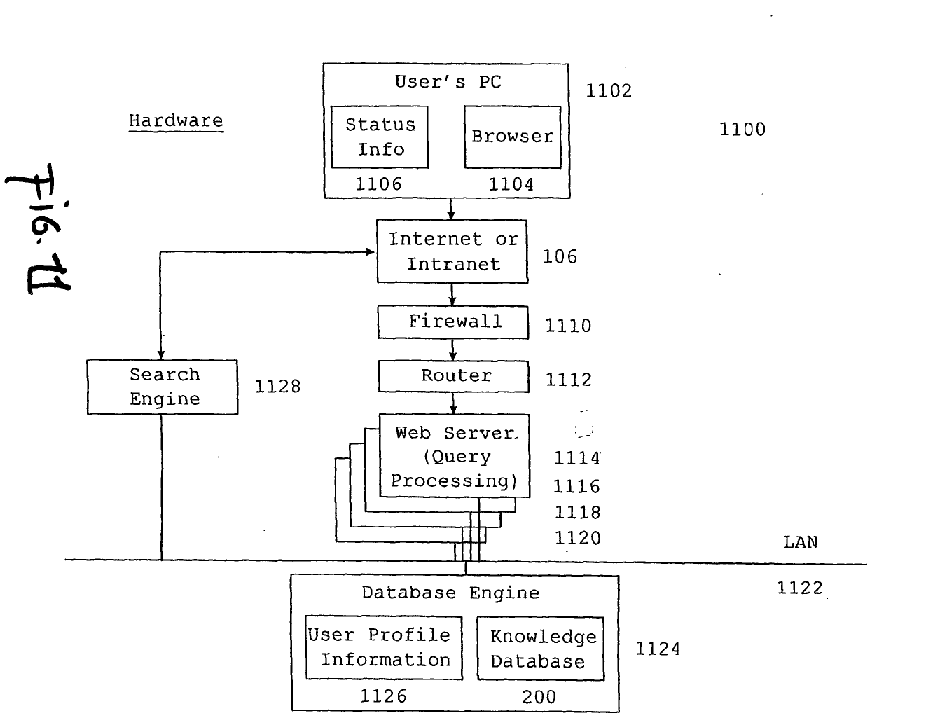

With reference to FIG. 11, a typical hardware environment for the present invention is disclosed. The system is accessed by the PC 1102 of the requestor which is equipped with a browser 1104 and which contains status information 1106 concerning the requestor's previous search activity, as will be explained. The PC 1102 communicates over the Internet or over an intranet 106 and through a firewall 1110 and router 1112 with one of several Web servers 1114, 1116, 1118, and 1120 that contain the interactive retrieval system procedure 100 that is depicted in overview in FIG. 1.

The router 1112 routes the incoming queries from many requesters' PCs uniformly to all of the Web servers that are available. Accordingly, a requestor does not know which Web server a requester will be accessing, and the requester will typically access a different Web server each time he or she submits a search term or answers a question posed by the system. Accordingly, each Web server 1114, 1116, 1118, and 1120 contains the same identical processing procedure shown in FIG. 1 but relies upon the requestor's PC 1102 to submit status information 1106 along with each submitted search term or submitted answer to a question posed by the system and to thereby advise the Web server 114 (etc.) as to where the requester is in the process of completing a given document retrieval operation and dialog.

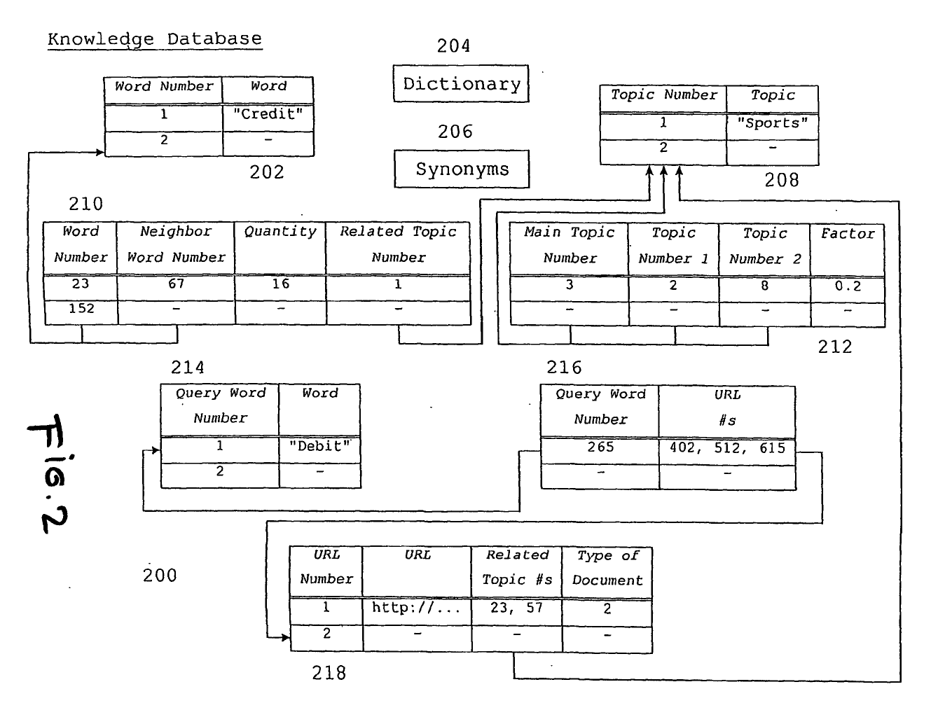

The Web servers 1114 (etc.) access a database engine 1124 over a local area network or LAN 1122. The database engine 1124 maintains a knowledge database 200 the details of which are shown in FIG. 2. This knowledge database contains a list of the previously-used query terms 214 and also a record of the indexing of the documents that contain those query terms 216 and 218, as determined by either manual or automatic indexing, as will be explained below. The database engine 1124 may also optionally contain requester profile information and the type of information that the requester is interested in. This may be used for a variety of purposes, including the selection of advertising for presentation on the requestor's PC 1102 in conjunction with searches such that the advertising corresponds to the interests of the requester.

When a Web server, e.g. 1114, encounters a new search term not already in the database 200, the Web searcher 1114 calls upon a search engine 1128 to conduct a new search of the Internet or intranet for documents that contain that particular search term. The results returned by the search engine 1128 are then processed by the Web server 1114 in a manner which is described below such that the search term (called a query word in FIG. 2), any newly-found documents (called URLs in FIG. 2), and the indexing of those documents (called TOPICS in FIG. 2) is recorded in the knowledge database 200 for use in implementing and speeding future searches.

Periodically, the Web servers 1114, etc., call upon the search engine 1128 to reexamine previously found documents to update and maintain the database 200 and to keep the entire system fully operational and up-to-date.

Referring now to FIG. 1, the procedures that comprise the interactive retrieval system 100 are illustrated in block-diagram overview. Requestor or user interface procedure 102, in the form of a downloadable Web page containing HTML and/or Java commands and the like, is established on each of the Web servers 1114 (etc.) at a Web address that any requestor may access (using a browser 1104 such as Netscape's Navigator or Microsoft Explorer) and thereby have a search query form downloaded from one of the Web servers 1114 (etc.) and painted upon the face of the requestor's PC 1102 display (not shown). In the preferred embodiment of the invention, this display presents the picture of a woman with whom the requester is hypothetically communicating, thereby adding a human touch to the interactive query process and simplifying the introduction of this system to beginners. In addition to possible advertising, this initial display will normally contain a window in which the requester can type a search term and then, by striking the enter key or by clicking on a button labeled GO or SUBMIT, have the search term transported back over the Internet or intranet to one of the Web servers 1114 (etc.). The search term is typically a single word, but it may also be several words or a phrase.

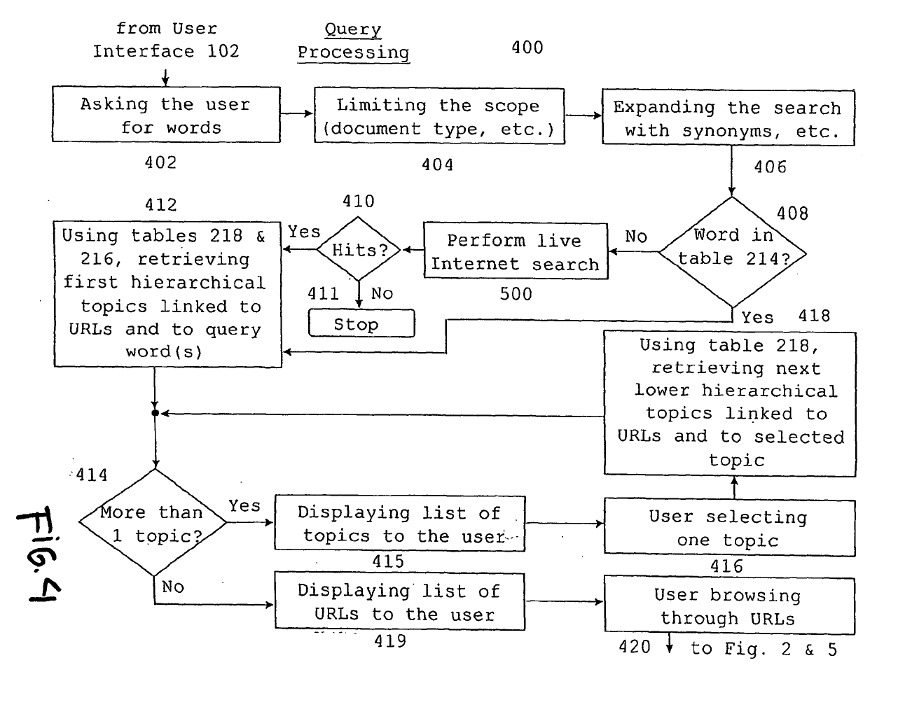

At the heart of the retrieval system software installed on the Web servers 1114, etc., is the query processing procedure 400, the details of which are shown in FIG. 4. When the requester supplies a search term to the query processing program 400 that the system has encountered before, the query processing program interacts directly with the knowledge database 200 to generate questions for the requester which are displayed to the requester or user by the user interface procedure 102 and which are lists of topics that are linked by tables to the documents which contain the search term supplied. Ultimately, after asking one or more such questions and receiving back replies, the system retrieves a list of document Web addresses or URLs (“Uniform Research Locators”) to display upon the requestor interface 102 to the requester, along with document titles, so that the requester may browse through the documents. In the case of search terms encountered previously, all of this is done without the assistance of the remaining software elements shown in FIG. 1.

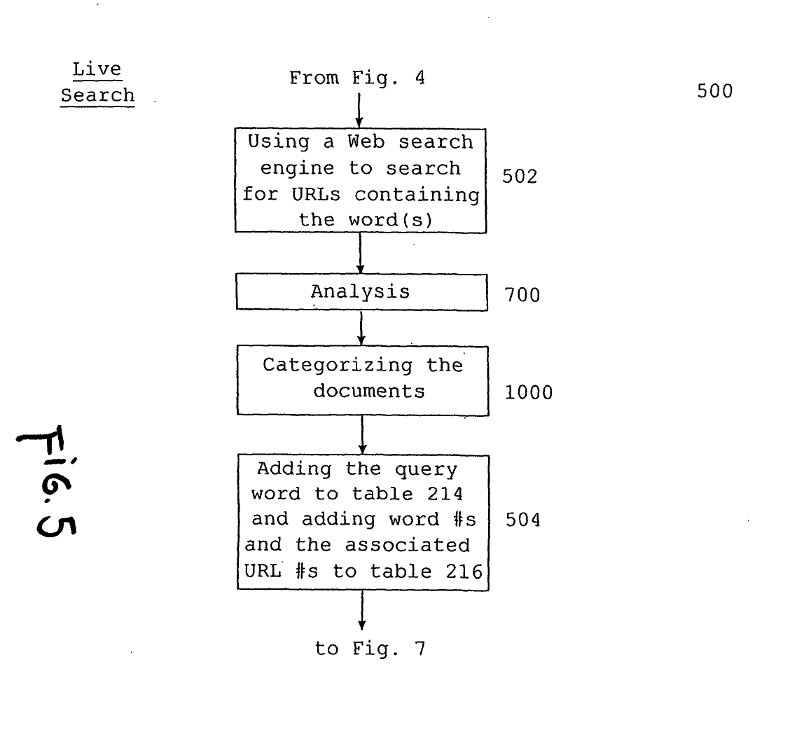

When a search term is received that has not been processed previously, before proceeding as described above, the query processing procedure 400 launches a live search for the term on the Internet or intranet using the live search procedure 500 the details of which are shown in FIG. 5. The documents captured by this live search are then analyzed by the analysis program 700 for their word and phrase content and are then assigned index topics (or categorized) by the categorizing procedure 1000. The knowledge database 200 is then updated with the new document URLs plus the indexing of those documents as well as the new search term (or query word), and then query processing 400 proceeds in the normal manner as was described briefly above.

Periodically, it is necessary to recheck the documents to see if they still exist out on the Web and to see if any of them have been changed. A timer 104 periodically triggers the update and maintenance procedure 600 to perform these functions using the analysis procedure 700 and the categorizing procedure 1000 to re-index documents that have been changed and also to remove query words from the database 200 when changes to the knowledge database 200 make it necessary for a query term search to be rerun as a live search if and when that same query term is encountered in the future.

The system is initialized through training using a small initial database that has been manually indexed such that each document in the training database is manually assigned to one or more index terms or categories or topics. This is done by a set-up procedure 300 in conjunction with the same analysis software 700 that is used to analyze the results of live searches and to perform update and maintenance activities, as has been explained.

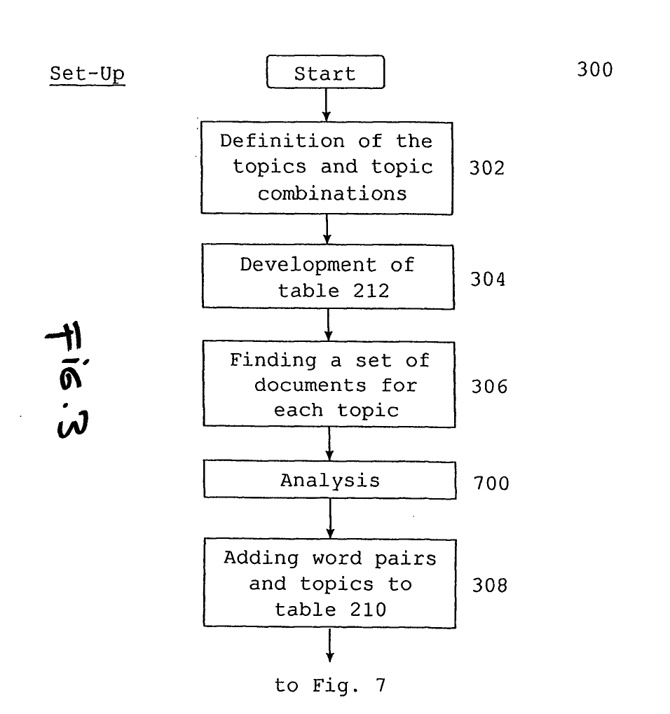

The first step in establishing an operative interactive retrieval system 100 is to exercise the set-up procedure 300, the details of which are shown in FIG. 3. This procedure 300 will be described in conjunction with a description of certain tables within the knowledge database shown in FIG. 2.

The process of setting up a retrieval system begins by the assembly of a database that has been indexed manually by the assignment of topics to the documents. Indexed databases are commercially available. For example, a newspaper will typically have a hierarchical index of all of its published articles, with the articles themselves also stored, in full-text machine-readable form, on a computer. Such an existing database would already satisfy the requirements of step 302, that of defining topics for inclusion in the topic table 208 shown in FIG. 2.

The goal, when it comes to assigning topics to documents manually, is not to define extremely narrow topics which are then assigned to a very limited number of documents, where individuals reading the documents might disagree with one another over which narrow topic subdivision each document is to be assigned to. Contrary to this, the topics are preferably broad and precise categorizations with which almost no one would disagree as to the assignment of the documents. Accordingly, news documents might be classified in accordance with broad topics such as sports, politics, business, and other such broad categorizations. The idea is to define topics which are easy to assign to the documents, yet which precisely divide the documents into separate categories for purposes of slicing up the database precisely and improving the precision of searching without degrading the recall of pertinent documents to any significant degree. Step 304, the development of topic combinations for entry into the table 212, is presently a manual operation intended to improve the performance of the retrieval system. It has been found that the text searching and text comparison aspects of the present invention will sometimes result in a document being determined to be related relatively equally to two differing topics. If these topics appear in the topic combination table 212, then the table will indicate a third main topic to which the document should be assigned. This third topic may be either one of the two topics, or it may be some different topic. The topic combination table has been found to be helpful because the categorization of a document to a topic by means of its word and phrase content, as described below, will sometimes produce ambiguous results that can be overcome by this intervention.

Step 306 in FIG. 3 calls for finding a set of documents for each topic. In the case of a pre-existing indexed newspaper database or the like, this has already been done, and it is only necessary to generate format conversion software which can read in the documents and their index assignments and build from those documents the word table 202, the topic table 208, and the word combination table 210.

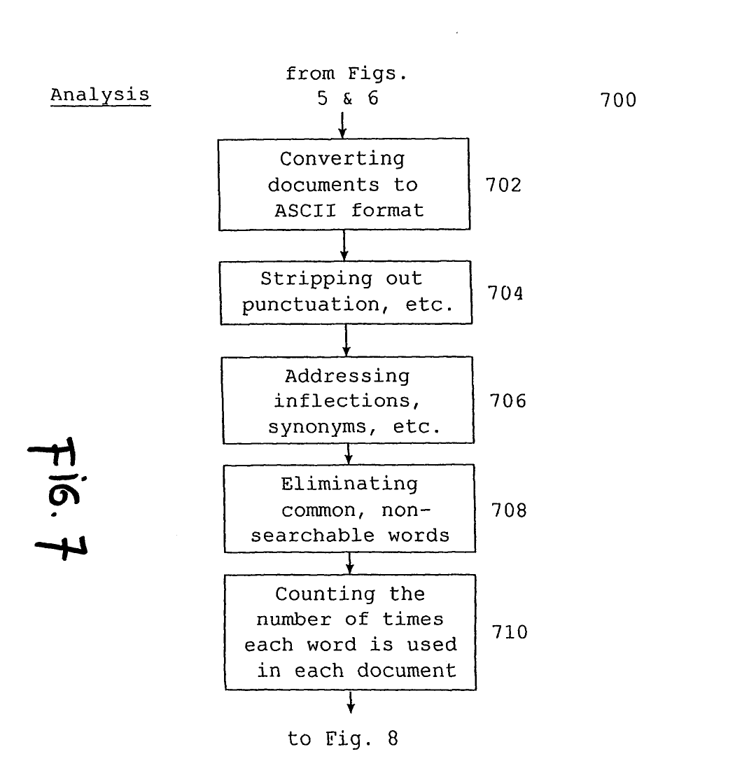

The entire process of building these tables begins with the analysis of the set of documents by the analysis procedure 700, a procedure that is described in detail in FIGS. 7, 8, and 9 and that is used not only in setting up the system but also to assign topics to documents found as a result of live searches performed as shown in FIG. 5. The analysis program 700 is described at a later point. Suffice it to say for now that the analysis program 700 goes through each indexed document and distills out of those documents the most commonly occurring words in each document that are searchable—that is, useful for distinguishing one document from another (excluding such non-useful, non-searchable words as articles, prepositions, conjunctions, etc.) These words are then entered into the word table 202, shown in FIG. 2, such that a word number is assigned to each of these words.

Next, the analysis procedure 700 searches for these same words and the adjacent or neighboring searchable words within the same document, and it selects from each document those word pairs that occur most frequently. The words in these searchable word pairs, to the extent not presently in the word table 202, are then assigned entries in the word table 202 and are thus also assigned word numbers.

After that, the word combination table 210 is assembled. All the topic names are first entered into the topic table 208 and are thus assigned topic numbers. Since the documents have all been assigned to topics, the word pairs associated with each document may then be assigned to the same topic numbers that are assigned to the corresponding documents. Accordingly, all the word pairs are entered into the word combination table 210 along with the topic number that is assigned to the document within which each word pair appears. In addition, the word combination table 210 contains an indication of the quantity of the word pairs that were found. In this simple manner, the set-up procedure creates a word combination table which associates word pairs with topics. The topic names appear in the topic table, and the words themselves appear in the word table. The word combination table contains nothing but numbers that are references to the other two tables, as indicated by the arrows shown in FIG. 2. In essence, the word combination table relates document word patterns to topics. This table is later used to assign topics to documents found during live searches, documents that are not manually indexed.

Next, and to the extent necessary, the topic combination table 212 is established to allow documents that appear to be associated with multiple topics to be assigned to one or the other of those two topics or to a third topic in cases where the assignment of a document to a single topic is ambiguous. The topic combination table also contains a factor entry as part of each table entry. The number of occurrences of the word pairs signaling two different topics in a single document is required to be almost the same, varying by no more than the factor amount, before the topic combination table is applied to trigger the alternate selection of a main topic. In the example shown in the table 212, the factor is 0.2, meaning that the word pairs suggestive of one topic must appear in a quantity within the document that is between 0.8 (1.0 minus 0.2) and 1.2 (1.0 plus 0.2) times of the number of occurrences of the word pairs that indicate the other topic before the topic combination table is used. Different factor values may be assigned to different word pairs to optimize the performance of the retrieval system, and other similar techniques may be employed. As in the case of the word combination table 210, the topic combination table 212 contains only topic numbers which refer back to the topic table 208 that contains the actual names of the topics.

That completes the process of setting up the retrieval system 100. If desired, and if the documents that have been used to create entries in the word combination table 210 are available on the Internet or on an intranet and accordingly have assigned to them URL addresses, then these documents, and up to four related topic numbers, may be entered into the URL table 218 in anticipation of these same documents later being retrieved because they contain a requestor's search term. But this step is optional. The exercising of the interactive retrieval system will, in the normal course of things, ultimately cause all documents that contain query search terms or interest to the requesters to be found and entered into the URL table 218 at a later time. The one advantage of entering these documents into the URL table 218 during the set-up procedure is that the manually-assigned topics will then be assigned to these documents, and there is no chance that the automatic topic assignment procedure (described later) might produce a slightly different topic assignment from that done manually. However, the main purpose of the set-up procedure is not to load the URL table 218 with documents but to load the word combination table 210 with the patterns of words that indicate a document being related to a particular topic. In the discussion that follows, the requester is normally a human user who wishes to have a search performed. It is also possible that the requester might be some other computer system utilizing this invention as a resource and adding value of its own to the process.

FIG. 4 presents a detailed block diagram of the query processing procedure 400 carried out by the present invention. The process begins at step 402 when the requester is prompted to supply a search term, typically a word, but possibly several words or a phrase or even words and phrases with logical connectors. Either at that time, or perhaps at an earlier stage, the requester may be queried as to how to limit the scope of a search at step 404. For example, the requester may wish to search only highly authoritative documents such as those published by the government in statutes, regulations, or other pronouncements. The requester may wish to include less authoritative but still generally reliable sources, such as newspaper and magazine articles. Or the search may be broadened further to include the scholarly publications of universities and science foundations. Even broader searches may include the publications of corporations, documents that may be more biased and less reliable but still authoritative. Finally, the requester may wish to search not only the above sources but also documents supplied by individuals on individual Web sites whose reliability is not necessarily high. Such documents may still be useful. A table may be displayed to the requestor enabling the requester to check the boxes of the various types or classes of information that the requester wishes to see. Alternatively, the requester may simply be asked to decide on the level of authoritativeness of the documents that are to be displayed: government and official publications only; government publications plus newspaper articles; government publications and newspaper articles plus university and scientific documents; these sources plus corporate information; and all sources of information, including information found on individual Web sites.

At step 406, the search term is analyzed. In part, this analysis involves normalizing the search term with respect to such things as spelling and inflection, normalizing the case of nouns and the tense of verbs, and also normalizing distinctions due to gender. Much of this may be language specific. In German, the character “β” might be translated into a “ss”, or vice versa. Inflection might also be normalized for search and comparison purposes through the addition or subtraction of mutated vowels (“ä”, “ö” and “ü”) or other language-specific accent marks.

Next, a synonym dictionary is checked at 206 to see if synonyms exist for the search term, and thus a search may be expanded to cover multiple terms having the same semantic meaning so that documents which do not contain the search query word but which contain a related synonym will also be included within the scope of the search.

While multiple search terms may have been supplied, the discussion which follows will assume for the sake of simplicity that only one term has been produced which needs to be processed. However, if multiple search terms need to be processed, the steps described below will simply be repeated for each term so as to increase the number of documents captured and analyzed and categorized. Likewise, the use of logical connectors might increase or decrease the number of documents that are analyzed and categorized, or their application might be postponed to a later stage of the process.

At step 408, a check is made to see if the search term already exists in the query word table 214. By way of explanation, every time a new search term is submitted by a requester, the search term is added to the query word table 214 as a new entry, and then a live Internet or intranet search is performed as described in FIG. 5. But once such a live Internet search has been performed, together with the analysis and categorization of the documents captured, the relevant information is preserved in the URL table 218 and in the query linkage table 216, and accordingly further live searching for that same search term is not needed until the system is updated and some of the documents are found to have been changed or deleted. Accordingly, if the query word is found already to exist in the query word table 214, then the live search procedure 500 can be bypassed, and processing continues with step 412 using the knowledge database shown in FIG. 2. In that case, no live Internet or intranet search would be required. But if the query search term is not found in the query word table 214, then at step 500, a live search is performed as explained in FIG. 5. If documents are found that contain the query term at 410, then processing continues at step 412. Otherwise, the search process is halted at step 411, and a report is given to the requester that no documents were found containing the submitted search term.

At step 412, it is presumed that a live search has already been performed for the search term and that the set of documents containing that term have already been analyzed and categorized, as will be explained below in conjunction with the description of FIG. 5. All documents containing the search term are thus listed in the URL table 218 along with up to four topics to which each document relates. In addition, the table 218 contains an indication of the type of each document (government publication, newspaper article, university or scientific publication, etc.) if that information is available.

The search term is looked up in the query word table 214, and then the query word number is searched for in the query linkage table 216. All the URL numbers associated with the search term are retrieved from the query linkage table 216. In the case of synonyms, all the URL entries for all of the synonyms are retrieved from the query linkage table 216.

Next, the URL table 218 is checked, and for each of the URLs captured, the first of the four topic numbers is retrieved. At step 414, if only one topic is assigned to all the documents, then the search is done, and the list of document URL addresses and titles is displayed to the requester at step 419. The requester is then permitted to browse through the URLs at step 420, displaying and browsing through the documents.

If more than one topic is found to be assigned to the documents, then at step 415 a list of the first topic in the table 218 for each document is displayed to the requester, and the requester is prompted to select one of the topics to thereby narrow the scope of the search to the set of documents so indexed.

At step 416, the requester selects one of the topics, and this information is conveyed back to the system 100 along with other information sufficient to define to the system 100 the current state of the requestor's search such that the Web servers 1114 (etc.) do not need to retain any information about any given requester and the status of any given search. This information is maintained as part of the status information 1106 within the requestor's PC.

The selected topic narrows the scope of the search to certain URLs within the URL table 218 that contain the selected topic's number. At step 418, the system next goes to the second of the four topic numbers (second from the left—57—in the RELATED TOPIC #s column of table 218) for those documents within the URL table that contained the selected topic number, and it assembles a list of different second-level topics. Once again, if there is only one second-level topic, or if there are none, then the list of document URLs and names is displayed to the requester at step 419, and the requester is permitted to browse through them. However, if there are several second-level topics, then the list of second-level topics is displayed to the requester at step 415, and the requester is again asked to select one topic at step 416.

This process of displaying a list of topics to the requester and having the requester select a topic or subtopic occurs a maximum of four times, since there are a maximum of four topic numbers listed in the URL table 218 for each document. Accordingly, there can be anywhere from zero to four such dialogs, with the system asking the requester to select from a list of topics, and with the requester responding by designating a single topic to narrow the focus of the search and to thereby improve the precision of the search substantially without suffering a reduction in the recall of relevant documents.

The procedure for performing a live search is set forth in FIG. 5. Whenever a word supplied by the requester is not found within the query word table 214, the word is a new one to the system 100, and the system must take steps to add to its knowledge database documents that contain this word. It must also analyze these documents and categorize them—assign them to topics. At step 502, the system commands a conventional Internet or intranet search engine 1128 to search the Internet or intranet for the URLs of documents that contain the word. In that preferred embodiment of the system 100, the system captures up to but no more than one thousand documents. This is far more documents than a human requestor would normally wish to browse through when conducting a conventional search of the Internet or intranet without using the present invention. Accordingly, the present system is able to achieve a higher recall rate than that achievable using a normal Internet or intranet systems. While the recall rate is high, it is to be expected that many, and perhaps most, of the documents captured at this stage will be irrelevant to the requestor's intentions, and thus at this stage search precision is quite low.

Next, at step 700, the system analyzes the set of documents retrieved, as will be explained below. Briefly summarized, the system determines the most commonly-occurring searchable words within each document, and then it identifies the pairing of these words with other adjoining searchable words thus associates a set of word pairings with each document. This set of word pairings constitutes a word pattern that characterizes each document and that can be used to match a document to other indexed documents and thus to assign one or more topics to each document in a later categorization step.

At step 1000, the document is categorized, as will be explained below. Briefly summarized, the word pairs characterizing each document are matched against word pairs in the word combination table 210, which the table relates to topics, and up to four topics may thereby be assigned to each document.

Finally, at step 504, the query words are added to the query word table 214, and the documents are entered into the URL table 218 along with their assigned topic numbers and URL identifiers. The query linkage table 216 is then adjusted so that all the documents entered into the table 218, identified by their URL number, are linked by the table 216 to the query words in the query word table 214 that the documents contain. In this manner, a thousand documents containing the search word are retrieved, analyzed, and categorized in an automatic fashion to the extent that their word patterns are similar to the word patterns of the manually indexed documents. The query words, documents, and the document indexing is thus entered into the knowledge database for use not only in processing this search but also in greatly speeding the processing of subsequent searches for the same word. Of course, a document encountered in a previous search is already indexed, categorized, and entered into the table 218. Only the query linkage table 216 needs to be adjusted to link such documents to the new query word.

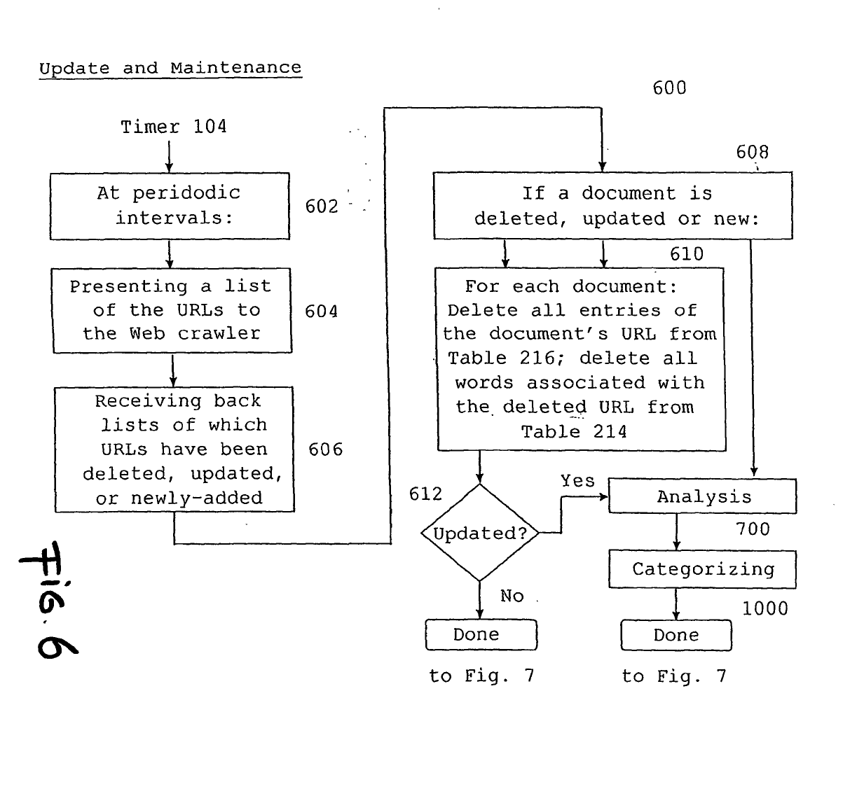

Periodically, it is necessary to go through the knowledge database to maintain it and update it so that it reflects the current status of the documents in the Internet or intranet. In FIG. 6, the update and maintenance procedure 600 is presented. This procedure 600 is executed periodically, as indicated at step 602, by some form of timer 104 (FIG. 1). However, the documents relating to some topics may be relatively stable and unchanging, while other documents relating to such things as current news events may change daily or even more frequently. Accordingly, the system designer may cause certain types of documents and documents related to certain topics to be updated much more frequently than others.

The update procedure begins by taking a list of the URL addresses contained in the URL table 218 and presenting the list to the search engine 1128 (FIG. 1) to find out which of the documents have been deleted and which have been updated or modified. To facilitate this, the document URLs should preferably be accompanied by the date upon which the documents were retrieved from the Internet to facilitate the Web crawler in determining whether or not they have been modified. At step 606, the Web crawler or search engine 1128 returns lists of those URLs which have been deleted or updated, and (optionally) those that have been added new to nodes where the documents are of such importance that the system preloads all the documents from those particular nodes.

At step 608, each document listed is examined, and different steps are executed depending upon whether a document has been deleted from the system, has been updated with a replacement, or is a new document added to a node where the system tests for the presence of new entries.

At 610, if a document has been either deleted or updated, it must be removed from the knowledge database. For each such document, all entries of the document's URL number are deleted from the query linkage table. In addition, the query words associated with the deleted URL are also removed from the query word table 214. Accordingly, in the future, if any of these query words are submitted again, the system will be forced to retrieve all of the documents containing these query words anew and to re-analyze and re-categorize these documents and re-enter them into the URL table 218.

Optionally, at step 612, if a document has been updated, it may be analyzed 700 and categorized 1000, and its entry in the URL table may be updated to reflect the topics that it now contains. If these steps are taken, then in the future, if a search word not present in the query word table causes a live search to be performed and if such a document is captured as part of the live search, the system will not need to analyze and categorize the document, since the analysis and categorization is already present within the URL table 218. The system will simply enter the search word into the query word table 214, and add the URL number of the document, along with the URL number of other documents linked to that query word, to the query linkage table 216.

If the system is designed to detect new documents at particular nodes, those new documents can also be analyzed 700 and categorized 1000 so that they may be entered into the URL table 218 in advance of those documents having been found because they contain a particular search word. Once again, later searches for search words that these documents contain will proceed more rapidly following a live search, since the document analysis and categorization steps will already have been completed and the URL table for such documents 218 will have already been updated.

FIGS. 7, 8, and 9 present a block diagram of the analysis procedure 700 that identifies key words and key word pairs within a document and that thereby identifies a word pattern that characterizes the information content of the document.

Analysis begins by converting the document from whatever format it is in, typically HTML with possibly the presence of Java scripts, into a pure ASCII document completely free of programming instructions, stylistic instructions, and other things not relevant to retrieval of the document based upon its semantic information content.

At step 704, all punctuation and other special characters are stripped out, leaving only words separated by some delimiter, such as the space character. At step 706, ambiguities in the words caused by variations in inflection, by synonyms, by variable use of diacritical marks, and by other such language specific problems are addressed. For example, the “β” in German might be replaced by “ss”, mutated vowels (“ä”, “ö” and “ü”) may be added or stripped, irregular spellings may be adjusted, and certain words that are interchangeable with synonyms may be reduced to one particular word for consistency in word matching.

Next, at step 708, the system strips out of the text the common, non-searchable words such as “the”, “of”, “and”, “perhaps”, words and phrases that occur commonly but that have little or no value in distinguishing one document from another. It can be expected that different implementations of the invention will vary widely in the ways in which they address these types of problems.

At step 710, the system counts the number of times each remaining word is used within each document.

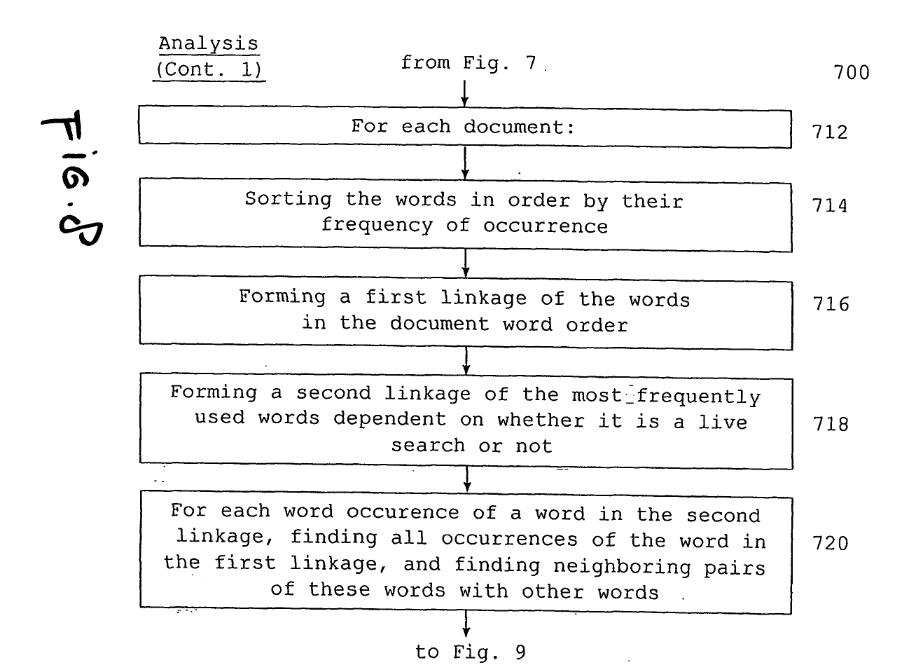

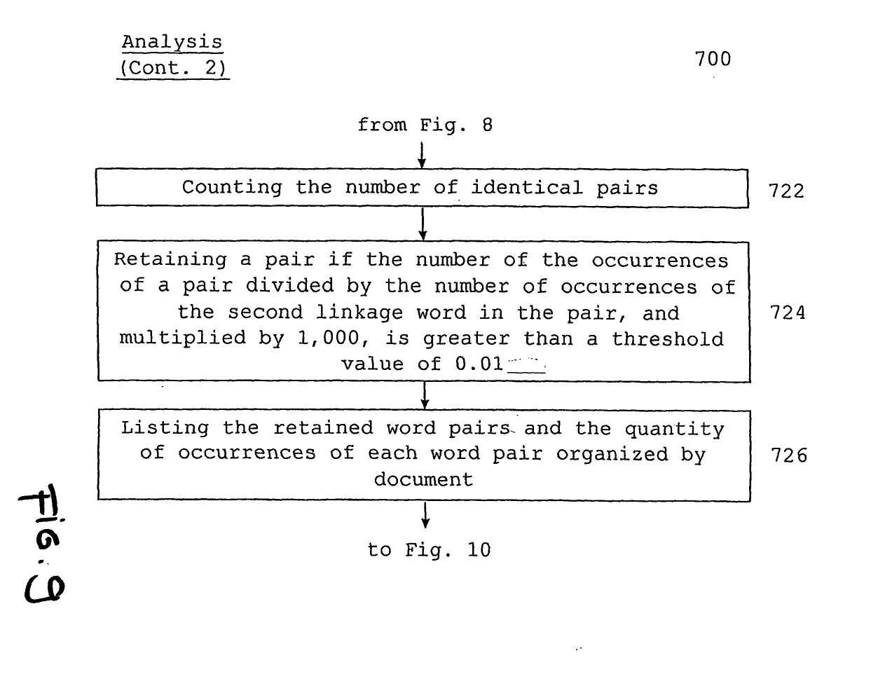

In FIGS. 8 and 9, step 712 indicates that the steps 714-724 are carried out with respect to each individual document that is to be analyzed.

At step 714, the words within a document are arranged in order by their frequency of occurrence within the document, such that the most frequently occurring words are at the top of the list. At step 716, a first linkage of the words within the document are formed in document word order. Then, at step 718, a second linkage is formed of the most frequently used words which appear at the top of the sort list prepared at step 714.

A limit is placed upon the number of words within each document that are included in the analysis. In the preferred embodiment of the invention, in the case of a live search, the system simply retains the thirty most frequently used words in the second linkage.

If a search is not a live search, but rather one performed during initial system set-up (FIG. 3) or during system update and maintenance (FIG. 6), then the number of words retained in the second linkage is adjusted in proportion to the size of the document. The test used in the preferred embodiment of the invention is that if the frequency of occurrence of a particular word divided by the document size (measured in kByte) is greater than or equal to 0.001, then the word is retained. Otherwise, it is discarded.

Next, for each occurrence within a document of a word in the second linkage of the most frequently occurring words, the system scans the first linkage (of the words arranged in document order), finds all occurrences of each of the words in the second linkage, and then identifies words in the first linkage adjacent to or neighboring each occurrence in the first linkage of words from the second linkage. In this manner, the system identifies pairings of the most frequently used words in each document with their immediately adjacent searchable neighbors.

At step 722, for each document, a count is made of the number of times each unique pairing of two such words occurs within each document.

At step 724, only the most frequently occurring of these pairings of two words are retained. In the preferred embodiment of the invention, a pairing of two words is retained if the number of occurrences of the pairing divided by the number of occurrences of the word in the pair that was among the most frequently occurring words in the document, all multiplied by one thousand, is greater than the threshold value of 0.001. Otherwise, the pairing is discarded.

Finally, at 726, for each document a list is formed of the retained word pairings and the quantities of occurrences of each word pairings. This completes the document analysis procedure.

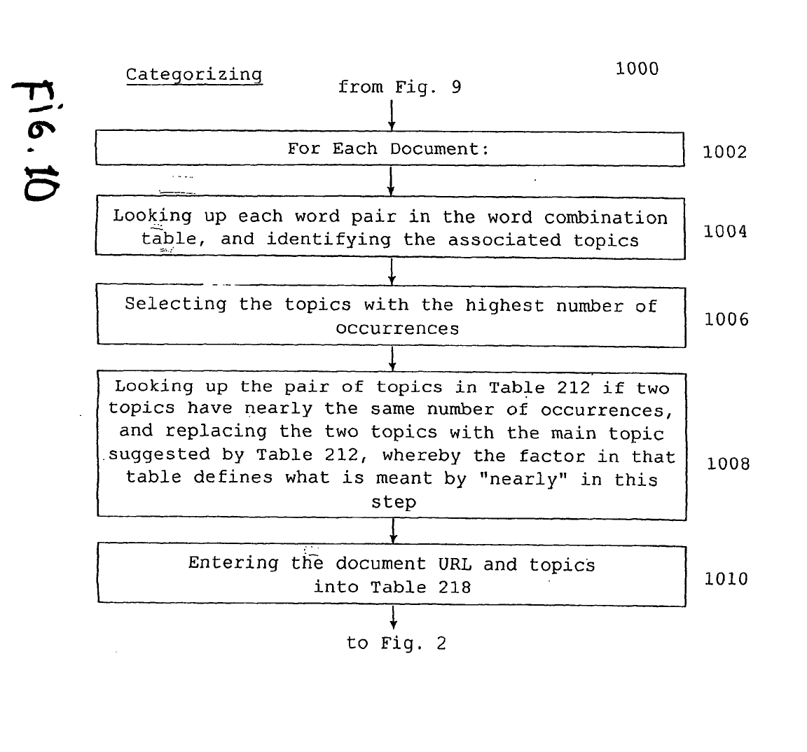

The categorizing procedure 1000 is set forth in block diagram form in FIG. 10. As indicated at steps 1002, the remaining steps 1004 through 1010 are performed for each document separately.

Categorizing begins by taking each retained pairing of words for the document (produced through analysis) and looking the pairing up in the word combination table 210 of the knowledge database. Some of the pairings may not be found in the word combination table 210, and these pairings are discarded. The remaining pairings, for which matching entries are found in the table 210, are assigned to the topics that are linked to those matching entries by the table 210.

At step 1006, the number of word pairings assigned to each topic are summed up, and the four topics assigned to the highest number of pairings within the document are then selected and retained as the four topics that characterize the topic content of the document. These four topics are arranged in order by the number of pairings each is assigned to, with the topic having the most pairings first, the topic with the next most pairings second, and so on.

At step 1008, the topic combination table 212 is checked. If two topics within the document are associated with nearly the same number of pairings, within the limits indicated by the factor entry in the topic combination table for those two topics, then the main topic number indicated by the topic combination table 212 is selected and is substituted for both of those topics to characterize the document.

Finally, the URL for each document is entered into the URL table 218 along with a number identifying the document type. The four selected topics, identified by their numbers, are also entered into the table 218. This completes the document categorization process.

To illustrate in more detail how the system works, examples Of several typical but simplified system operations are set Forth below.

The knowledge database 200 of the system is presumed to contain the following information:

The topic table 208 contains:

| Topic Number | Topic |
|---|---|
| 1 | “Baseball” |
| 2 | “Medicine” |
| 3 | “Rules” |
| 4 | “Medicine in Sports” |

The word combination table 210 contains:

| Word | Neighbor | | Related Topic |
|---|---|---|---|
| Number | Word Number | Quantity | Number |
| 3 | 4 | 2 | 3 |
| 2 | 5 | 3 | 2 |

The topic combination table 212 contains:

| Main Topic | Topic | Topic |
|---|---|---|
| Number | Number 1 | Number 2 |
| 4 | 1 | 2 |

The query word table 214 contains:

| Query Word | |
|---|---|
| Number | Word |
| 1 | “Pitcher” |
| 2 | “Headache” |
| 3 | “Quarterback” |
| 4 | “Baseline” |
| 5 | “Alka-Seltzer” |

The query linkage table 216 contains:

| Query Word | URL |
|---|---|
| Number | Numbers |
| 1 | 47, 59, 23 |
| 2 | 19, 17 |
| 3 | 20 |

The document URL table 218 contains:

| URL | | | Topic |
|---|---|---|---|
| Number | URL | Class | Numbers |
| 17 | http:// . . . | “Official” | 2, 9, 13 |
| 19 | http:// . . . | “Company” | 2, 8, 33 |
| 20 | http:// . . . | “Media” | 2 |
| 23 | http:// . . . | “Individual” | 1, 3, 4 |

### EXAMPLE 1

### Searching Through Multiple Hierarchy Levels

If the requester enters the search term “headache”, the system looks up that word in the dictionary 204 to ensure correct spelling and also addresses problems of inflection, etc. Next, the system checks through the list of synonyms 206, and if any are found, the system expands the search to search for both terms. When all of these preliminary steps have been completed, the system looks up the word “headache” in the query word table 214 to see if this term has been searched for previously. In this case, the term has been searched for previously, and accordingly, “headache” appears as a query word that the table 214 assigns the query word number of 2.

Having identified the word and discovered that it had been searched for previously, the system now searches the query linkage table 216 for and retrieves from that table the URL table 218 numbers of all the documents that contain the word. In this case, the URL numbers 17 and 19 are found in the query linkage table 216.

Accordingly, the system next checks the URL table 218 entries for documents assigned URL numbers 17 and 19, and it examines the topic numbers assigned to the two documents 17 and 19. As can be seen, document 17 is assigned to the topic numbers 2, 9, and 13, while document 19 is assigned to the topic numbers 2, 8, and 33. The leftmost of these topics (2 and 2) are ranked higher in the hierarchy of topics, since the leftmost topics are associated with more word pairings in the document than the other topics, as has been explained. Accordingly, both of the documents are most strongly linked to topic number 2, which the topic table 208 reveals is “medicine”.

The system may now display to the requestor the word “medicine” and the number 2 indicating the number of documents that have been found related to the entered search term. The requester will, of course, select this topic. (In some implementations, the display of a single topic may be bypassed as unnecessary.) The system then responds by displaying all the topics listed at the second level of the hierarchy, in this case, the topics numbered 8 and 9 (the names of these topics are not included in the illustrative topic table). These two topics are then displayed to the requester each followed by one, the number of documents relating to each topic, and the requester is prompted to select one or the other. Assuming the requester selects topic number 8, then the system displays to the requester the URL address and the document name corresponding to the document assigned the URL number 19 in the URL table 218. The third hierarchical topic 33 is not displayed to the requester. Since it is the only topic left, there is no reason to display it.

### EXAMPLE 2

### Searching Through Only One Hierarchical Level

Assuming now that the requester enters the search term “Alka-Seltzer” the system will first check that word against the dictionary 204 and synonyms 206 tables described in Example 1 and address inflection and other problems. After all the necessary checks have been completed, the system goes to the query word table and learns that “Alka-Seltzer” has previously been searched for and has been assigned to the query word number. Accordingly, the system then looks up this word number in the query linkage table 216 and learns that only a single document, assigned to the URL number 20, contains that word. With reference to the URL table 218, the document 20 is only assigned to the one topic number 2. Accordingly, there is no need for interaction with the requester. The single document URL address and document title are displayed to the requester so that the requester may decide whether to browse through the document.

### EXAMPLE 3

### The Search Term does not Appear in the Query Word Table

Assume the requester enters the word “heartache” and that the system can not find this in the query word table 214, since this search has never been performed before. After addressing spelling, inflection, and synonym problems, the system commences a live search (FIG. 5) and captures a number of documents that contain “heartache”.

Through the process of analysis 700 (FIGS. 7, 8 and 9) and categorizing 1000 (FIG. 10), the system adds all the captured documents and the related assigned topics to the URL table 218. This process involves finding adjoining word pairings within each document, looking them up in the word combination table 210, retrieving the associated topic numbers from the table 210, and then going through the process described above of selecting up to four most relevant topics for each document and placing the topic numbers of those four topics, along with the URL address of each document, into the URL table 218. The query linkage table is then adjusted to link “heartache” in the query word table to the documents found.

After completing these steps, the system continues as described in Example 1 above to complete the search.

### EXAMPLE 4

### Addressing Language-Specific Problems

In the spoken German language, there is a difference in spelling between the cases of a noun (nominative, genitive, dative or accusative). Accordingly, the German noun “Kopfschmerz” can be declined as follows:

| Grammatical Term | Noun Declension |
|---|---|
| Nominative Case (singular) | “der Kopfschmerz” |
| Genitive Case (singular) | “des Kopfschmerzes” |
| Dative Case (singular) | “dem Kopfschmerz” |
| Accusative Case (singular) | “den Kopfschmerz” |

The document might also contain the plural form of “Kopfschmerz”, which is “die Kopfschmerzen”. Said noun is then declined as follows:

| Grammatical Term | Noun Declension |
|---|---|
| Nominative Case (plural) | “die Kopfschmerzen” |
| Genitive Case (plural) | “der Kopfschmerzen” |
| Dative Case (plural) | “den Kopfschmerzen” |
| Accusative Case (plural) | “die Kopfschmerzen” |

All of these different forms of inflection are converted downwards into the same basic ground form of the noun for searching and comparison purposes.

Likewise, the system must also contend with different inflections of a verb. For example, the German verb “laufen” is conjugated as follows (using the Present Tense):

| Grammatical Term | | Verb Conjugation |
|---|---|---|
| 1^{st} | Person Form (singular) | “ich laufe” |
| 2^{nd} | Person Form (singular) | “du läufst” |
| 3^{rd} | Person Form (singular) | “er/sie/es läuft” |
| 1^{st} | Person Form (plural) | “wir laufen” |
| 2^{nd} | Person Form (plural) | “ihr lauft” |
| 3^{rd} | Person Form (plural) | “sie laufen” |

During analysis, all of these variant verb forms must be flattened to the ground form so as to reduce the number of words that have to be analyzed and to improve the semantic performance of the system.

While the preferred embodiment of the invention has been described, it is to be understood that numerous modifications and changes will occur to those skilled in the art of retrieval system design that fall within the true spirit and scope of the invention. The claims appended to and forming a part of this specification are therefore intended to define the invention and its scope in precise terms.

As can be taken from FIG. 12, the core elements of the novel search engine 1204 according to the preferred embodiment of the underlying invention are the filtering module 1204a (for HTML, XML, WinWord, PDF, and other data formats), the analysis module 1204b, and the newly developed knowledge database 1204c. Additionally, optional modules 1202 and/or 1206 can be employed. Particularly, these optional modules comprise:
a customized user interface 1206,
a full-text search 1202 for documents along with a decentralized document monitoring,
an interface to the Internet using classical search engines and/or newly developed search strategies,
an interface to professional databases,
interfaces to further customer applications.

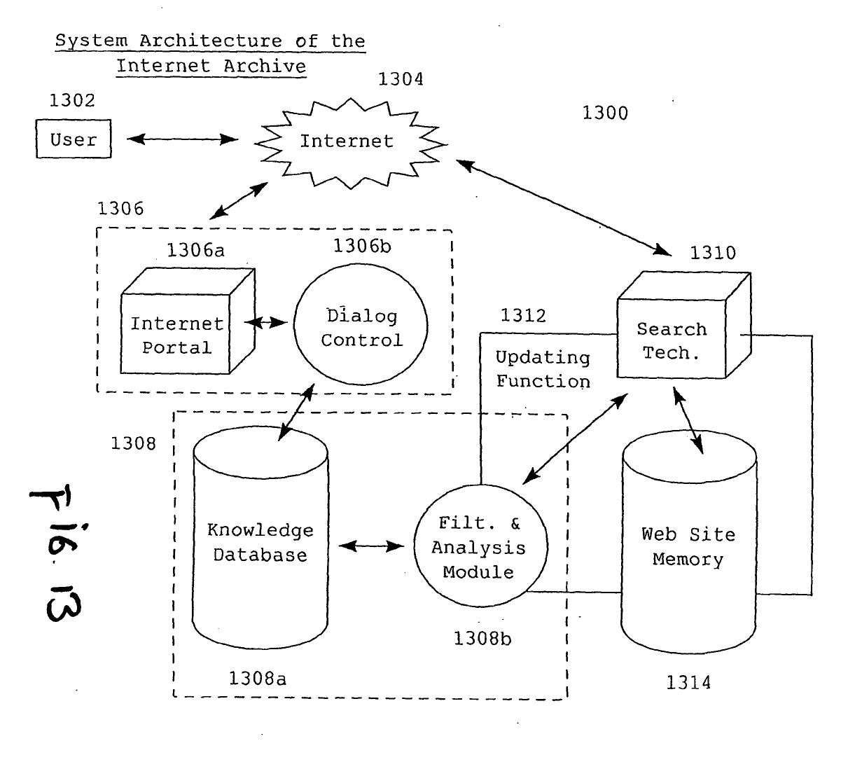

FIG. 13 exhibits an overview of the system architecture and the co-operation of the components used for the Internet archive 1300 according to the preferred embodiment of the underlying invention. The components 1308a and 1308b form the search engine 1308, which is the heart of said Internet archive 1300. This architecture is complemented by the search technique 1310, the updating function 1312 and the Web site memory 1314 according to the underlying invention. Furthermore, the novel user interface 1306 is presented consisting of the Internet portal 1306a and the dialog control 1306b.

Thereby, a search query is processed according to the following scheme: The customer turns to the Internet archive according to the preferred embodiment of the underlying invention via the Internet with the aid of his Web browser. His entered search queries are received by a dialog control module. The associated documents are presented to the user from that database, in which the category information for already analyzed documents (Web sites) are stored.

Meanwhile, an updating function continuously runs in the background to keep the information stored within the knowledge database up-to-date. Thereby, modified and new documents are analyzed by the search engine according to the underlying invention with regard to their contents. The corresponding category information is stored in said knowledge database.

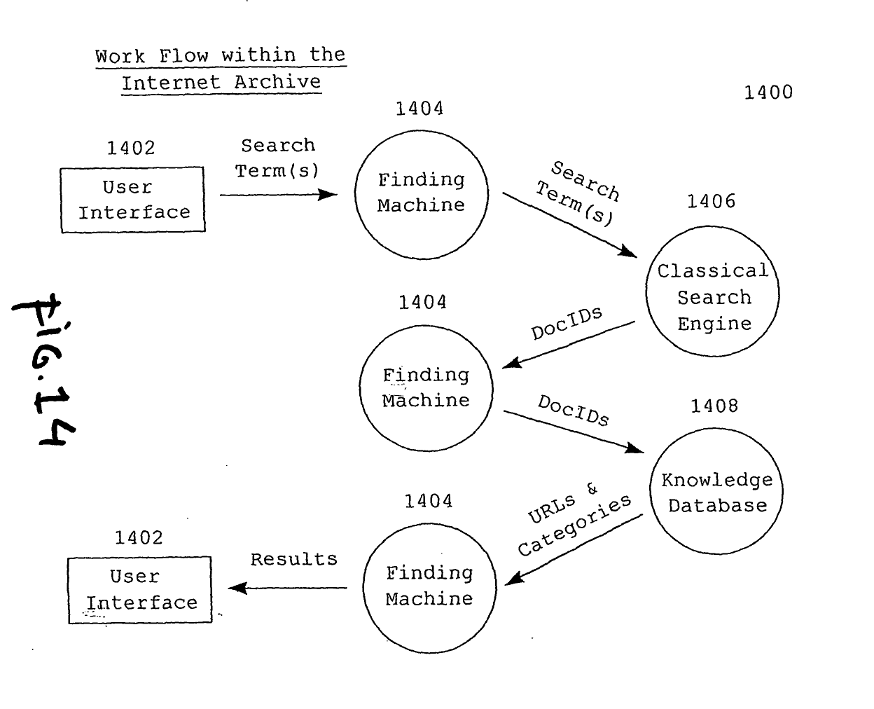

The work flows of the Internet archive 1400 as depicted in FIG. 14 according to a preferred embodiment of the underlying invention are based on the following components:
a classical search engine 1406 applied to the Internet,
the newly designed search engine 1204 (see FIG. 12),
specially designed presentation programs 1402 for the Internet comprising PHP programs for generating HTML texts, and a so-called “finding machine” 1404 for the integration of the classical search engine 1406 and the newly designed search engine 1204 (see FIG. 12),
an universally applicable thesaurus with approximately 50 categories and associated start documents.

When a search query has been entered by means of the user interface 1402, said search query is passed on by the finding machine 1404 to the classical search engine 1406. As a result the user receives a number of references which are related to documents (DocIDs) including the searched term. The finding machine 1404 initiates a test whether the obtained references to documents stored within the knowledge database 1408 according to the preferred embodiment of the underlying invention are already known. Each known and already available reference along with its associated category is then returned to the finding machine 1404 as a result. References which are unknown are transferred into a list, thereby requesting to fetch these documents from the Internet, to filter and analyze them, and to store the result of said analysis into the knowledge database. An individual process realized as an updating algorithm continuously checks whether the above-mentioned list has been updated, and executes all necessary steps. Finally, the finding machine 1404 presents the obtained results corresponding to the entered search term.

The significance of the symbols designated with reference signs in the FIGS. 1 to 14 can be taken from the appended table of reference signs.

Table of the depicted features and their corresponding reference signs

| No. | Feature |
|---|---|
| 100 | block diagram for the interactive information retrieval system (cf. FIG. 1) |
| 102 | user interface |
| 104 | timer |
| 106 | connection to the Internet or any corporate network |
| 200 | knowledge database (cf. table overview in FIG. 2) |
| 202 | word table |
| 204 | dictionary |
| 206 | synonyms |
| 208 | topic table |
| 210 | word combination table |
| 212 | topic combination table |
| 214 | query word table |
| 216 | query linkage table |
| 218 | URL table |
| 300 | set-up (cf. flowchart in FIG. 3) |
| 302 | step for defining the topics and topic combinations |
| 304 | step for developing the topic combination table |
| 306 | step for finding a set of documents for each topic |
| 308 | step for adding word pairs and topics to the word combination table, with words |
| | and topics entered into word and topic tables |
| 400 | query processing (cf. flowchart in FIG. 4) |
| 402 | Step for asking the user for at least one word |
| 404 | step for limiting the scope (document type, etc.) |
| 406 | step for expanding the search (with synonyms, etc.) |
| 408 | branching out comprising a question for finding out whether a word is in the query |
| | word table |
| 410 | branching out comprising a question for finding out whether hits were made |
| 411 | step for stopping the search |
| 412 | step for using URL and linkage tables, retrieving first hierarchical topics linked to |
| | the URLs and to the query words |
| 414 | branching out comprising a question for finding out if more than one topic shall be |
| | assigned |
| 415 | step for displaying the list of topics to the user |
| 416 | step for the user selecting one of the topic |
| 418 | step for using the URL table, retrieving the next lower hierarchical topics linked to |
| | the URLs and to the selected topic |
| 419 | step for displaying the list of URLs to the user |
| 420 | step for the user browsing through the URLs |
| 500 | live search (cf. flowchart in FIG. 5) |
| 502 | step for using a Web search engine to search for up to 1,000 URLs containing the |
| | entered query word(s) |
| 504 | step for adding the query word to the query word table and adding the query word |
| | #s and the associated URL #s to the linkage table |
| 600 | update and maintenance (cf. flowchart in FIG. 6) |
| 602 | step for measuring periodic time intervals which may vary from topic to topic |
| 604 | step for presenting a list of the URLs to the Web crawler |
| 606 | step for receiving back lists of which URLs have been deleted, updated, or newly |
| | added |
| 608 | branching out comprising a question for finding out if a document is deleted, |
| | updated or newly added |
| 610 | step comprising a loop for each document for deleting all entries of the document's |
| | URL from the query linkage table, and deleting all words associated with the |
| | deleted URL from the query word table |
| 612 | branching out comprising a question for finding out if a document has been |
| | updated |
| 700 | analysis of the set of retrieved documents |
| | (cf. flowchart in FIGS. 7, 8 and 9) |
| 702 | step for converting a document to an ASCII document |
| 704 | step for stripping out punctuation, etc., leaving words separated |
| | by delimiters |
| 706 | step for addressing inflections, synonyms, and other language-specific problems |
| 708 | step for eliminating common, non-searchable words like articles, prepositions, |
| | conjunctions, etc. |
| 710 | step for counting the number of times each word is used in each document |
| 712 | loop for each document comprising the following steps 714 to 726 |
| 714 | step for sorting the words in order by their frequency of occurrence |
| 716 | step for forming a first linkage of the words in the document word order |
| 718 | step for forming a second linkage of the most frequently used words (if it is a live |
| | search, then the 30 most frequently used words are retained; if it is not a live |
| | search, then the number of retained words for the size of the document is adjusted, |
| | thereby retaining a word if the frequency of its occurrence divided by the document |
| | size is greater than or equal to 0.001) |
| 720 | step comprising a loop for each occurrence of a word in the second linkage for |
| | finding all occurrences of the word in the first linkage, and for finding the |
| | neighboring pairs of these words with other words |
| 722 | step for counting the number of identical pairs |
| 724 | step for retaining a pair if the number of the occurrences of a pair divided by the |
| | number of occurrences of the second linkage word in the pair, and multiplied by |
| | 1,000, is greater than a threshold value of 0.01 |
| 726 | step for listing the retained word pairs and the quantity of occurrences of each |
| | word pair organized by document |
| 1000 | categorization of the documents (cf. FIG. 10) |
| 1002 | loop for each document comprising the following steps 1004 to 1010 |
| 1004 | step for looking up each word pair in the word combination table, and identifying |
| | the associated topics |
| 1006 | step for selecting the topics with the highest number of occurrences |
| 1008 | step for looking up the pair of topics in the topic combination table if two topics |
| | have nearly the same number of occurrences, and replacing the two topics with the |
| | main topic suggested by the topic combination table, whereby the factor in that |
| | table defines what is meant by “nearly” in this step |
| 1010 | step for entering the document URL and topics into the URL table |
| 1100 | overview of the employed hardware (cf. FIG. 11) |
| 1102 | personal computer (PC) of the user |
| 1104 | browser |
| 1106 | status information |
| 1110 | firewall |
| 1112 | router |
| 1114 | Web server for processing queries |
| 1116 | Web server for processing queries |
| 1118 | Web server for processing queries |
| 1120 | Web server for processing queries |
| 1122 | local area network (LAN) |
| 1124 | database engine |
| 1126 | user profile information |
| 1128 | search engine |
| 1200 | overview of the novel search engine (cf. FIG. 12) |
| 1202 | optional module for searching documents using specific tools |
| 1204 | novel search engine |
| 1204a | filtering module of the novel search engine |
| 1204b | analysis module of the novel search engine |
| 1204c | knowledge database of the novel search engine |
| 1206 | optional module for presenting the obtained results |
| 1300 | overview of the system architecture of the Internet archive and the co-operation of |
| | the components applied therein (cf. FIG. 13) |
| 1302 | user's PC |
| 1304 | Internet |
| 1306 | user interface |
| 1306a | Internet portal |
| 1306b | dialog control |
| 1308 | novel search engine |
| 1308a | knowledge database of the novel search engine |
| 1308b | filtering and analysis modules |
| 1310 | search technique |
| 1312 | updating function |
| 1314 | Web site memory |
| 1400 | work flow within the Internet archive (cf. FIG. 14) |
| 1402 | user interface |
| 1404 | finding machine |
| 1406 | classical search engine |
| 1408 | knowledge database |

1. An interactive document retrieval system (100) designed to search for documents after receiving a search query from a requestor, said system comprising: a knowledge database (200) containing at least one data structure (202, 208, 210, 212, 214, 216 and/or 218) that relates text patterns to topics, and a query processor (400) that, in response to the receipt of a search query from a requester, performs the following steps:
searching for and trying to capture documents containing at least one term related to the search query, if any documents are captured,
analyzing the captured documents to determine their text patterns,
categorizing the captured documents by comparing each document's text pattern to the text patterns in the knowledge database (200),
and if a document's text pattern is similar to a text pattern in the knowledge database (200), assigning to that document the similar word pattern's related topic,
presenting at least one list of the topics assigned to the categorized documents to the requester, and
asking the requester to designate at least one topic from the list as a topic that is relevant to the requestor's search, and
granting the requestor access to the subset of captured and categorized documents to which topics designated by the requestor have been assigned,
wherein the word patterns determined by analysis are pairings of words, each pairing comprising two searchable words with one word occurring frequently within the document and the other word occurring near the one word frequently within the document.

2. An interactive document retrieved system according to claim 1, characterized in that, the query processor performs the step of analyzing using an hybrid method based on linguistic and mathematical approaches for an automatic text categorization.

3. An interactive document retrieval system (100) in accordance with claim 1, wherein the knowledge base (200) is initially constructed by analyzing indexed documents to which topics have previously been assigned, thereby determining the indexed document's word patterns, and then storing in the knowledge database (200) these word patterns for the indexed documents and the topics assigned to these documents, and then relating the word pattern of an indexed document to the topics assigned to that same indexed document.

4. An interactive document retrieval system (100) in accordance with claim 1, wherein the search query contains a phrase, and the term searched for is that phrase.

5. An interactive document retrieval system (100) in accordance with claim 1, wherein the search query contains at least one word, and the term searched for is at least one searchable word taken from the search query.

6. An interactive document retrieval system (100) in accordance with claim 1, wherein the search query contains several words, the term searched for is a searchable word taken from the search query, and several words in the search query are searched for in separate searches.

7. An interactive document retrieval system (100) in accordance with claim 1, wherein the search query contains at least one operator and at least one word, and the presentation of documents to the requester scope is limited by the search query.

8. An interactive document retrieval system (100) in accordance with claim 1, wherein the knowledge database (200) retains a record of words previously searched for, the documents captured by such previous searches, and the index terms assigned to the captured documents, and the knowledge database (200) also retains linkages between the words previously searched for and the documents captured by such previously-conducted searches, such that the search, analysis, and categorizing steps may be bypassed when a word previously searched for is encountered in a later search query.

9. An interactive document retrieval system (100) in accordance with claim 8, wherein the knowledge database (200) is initially constructed by analyzing indexed documents to which topics have previously been assigned, thereby determining the indexed document's word patterns, and then storing in the knowledge database (200) these word patterns for the indexed documents and the topics assigned to these documents, and then relating the word pattern of an indexed document to the topics assigned to that same indexed document.

10. An interactive document retrieval system (100) in accordance with claim 8, wherein the knowledge database (200) is maintained by periodically checking to see if documents entered into the knowledge database (200) have changed or been deleted from the searchable universe of documents, and if they have, then deleting all reference to such documents, as well as the words searched for that caused their capture, from the knowledge database (200), thereby forcing all searches for such words likely to capture such documents to be repeated anew if encountered in a later search query.

11. An interactive document retrieval system (100) in accordance with claim 8, wherein the knowledge database (200) is maintained by periodically checking to see if documents entered into the knowledge database (200) have been changed, and if so, reanalyzing and re-categorizing such documents and also removing from the knowledge database (200) linkages between such documents and words that they no longer contain.

12. An interactive document retrieval system (100) in accordance with claim 1, wherein the knowledge database (200) is updated by periodically checking for new documents at some locations within the searchable universe of documents, and analyzing and categorizing such documents prior to those documents being captured by a search.

13. An interactive document retrieval system (100) in accordance with claim 1, wherein said knowledge database (200) includes a topic combination table (212) containing replacement topics for certain combinations of other topics that may appear within a captured document and that are assigned to such a document as a replacement for said other topics to improve categorization.

14. An interactive document retrieval system (100) in accordance with claim 1, wherein plural topics are assigned to at least some documents during categorization and are arranged hierarchically and linked to the at least some documents in the knowledge database (200), and wherein as many lists of topics as there are hierarchical topics associated with the categorized documents are presented to the requestor in sequence, such that the requestor designates multiple topics and subtopics, and such that search precision is improved by eliminating documents irrelevant to the requestor's designated topics from those to which the requestor is granted access.

15. An interactive document retrieval system (100) in accordance with claim 14, wherein the presentation of topics to the requester at any given hierarchical level is suppressed when all the documents are associated with the same topic at that level.

16. An interactive document retrieval system (100) in accordance with claim 1, wherein analysis includes the following steps: reduce the document data to a list of words; address inflection and synonym problems; eliminate non-searchable words; select the most frequently occurring words; and select frequently occurring pairings of those words with adjacent words in the document.

17. An interactive document retrieval system (100) in accordance with claim 16, wherein up to a predefined number of the most frequently occurring words are selected.

18. An interactive document retrieval system (100) in accordance with claim 16, wherein a word occurs frequently if the number of times it appears within a document divided by the total word content of the document exceeds a predetermined value.

19. An interactive document retrieval system (100) in accordance with claim 1, wherein a pairing occurs frequently if the number of occurrences of a given pairing within a given document, divided by the number of occurrences of the frequently-occurring adjacent word of the pairing within the document, is greater than a predetermined value.

20. An interactive document retrieval system (100) in accordance with claim 1, wherein:
the query processor (400) is installed in at least one Web server connecting to the Internet or to an intranet;
the knowledge database (200) is installed on a database engine (1124) accessible to the Web server;
the requestor communicates with the Web server (1114, 1116, 1118 or 1120) using a computer (1102) having a browser (1104) also connecting to the Internet or to the same intranet;
and searches are performed by a search engine (1128) accessible to the Web server (1114, 1116, 1118 or 1120) and conducting searches on the Internet or on the same intranet.

21. An interactive document retrieval system (100) in accordance with claim 20, wherein the predetermined value is in the neighborhood of 0.0001.

22. An interactive document retrieval system (100) in accordance with claim 20, wherein multiple Web servers (1114, 1116, 1118 or 1120) are employed, interconnected to the Internet or to an intranet by a router (1112) and a firewall (1110); and the status of any given search procedure is maintained on the requestor's computer (1102) and is resubmitted to one of the Web servers (1114, 1116, 1118 or 1120) each time a search query or designation is submitted by the requestor.

23. An interactive document retrieval system (100) in accordance with claim 1, wherein the knowledge database (200) contains a word table (202), a dictionary (204) and synonyms (206), a topic table (208), a word combination table (210), a topic combination table (212), a query word table (214), a query linkage table (216), and an URL table (218).

24. An interactive method of searching for and retrieving documents after receiving a search query from a requestor, said method comprising the steps of:
providing a knowledge database (200) containing at least one data structure (202, 208, 210, 212, 214, 216 and/or 218) that relates text patterns to topics,
in response to the receipt of a search query from a requester, searching for and attempting to capture documents containing at least one term related to the search query,
if any documents are captured, analyzing the captured documents to determine their text patterns,
categorizing the captured documents by comparing each document's text pattern to the text patterns in the knowledge database (200),
and when a document's word pattern is similar to a text pattern in the knowledge database (200), assigning to that document the similar text pattern's related topic,
presenting at least one list of the topics assigned to the categorized documents to the requester, and asking the requester to designate at least one topic from the list as a topic that is relevant to the requestor's search,
and granting the requestor access to the subset of captured and categorized documents to which topics designated by the requester have been assigned,
wherein the word patterns determined by analysis are pairings of words, each pairing comprising two searchable words with one word occurring frequently within the document and the other word occurring near the one word frequently within the document.

25. An interactive method according to claim 24, wherein the step of analyzing is carried out using an hybrid method based on linguistic and mathematical approaches for an automatic text categorization.

26. An interactive method of searching in accordance with claim 24, which further includes constructing the knowledge database (200) by analyzing indexed documents to which topics have previously been assigned, thereby determining the indexed document's word patterns, and then storing in the knowledge database (200) these word patterns for the indexed documents and the topics assigned to these documents, and then relating the word pattern of an indexed document to the topics assigned to that same indexed document.

27. An interactive method of searching in accordance with claim 24, which accepts at search queries that contain a phrase and that search for the phrase.

28. An interactive method of searching in accordance with claim 24, which accepts search queries that contain at least one word and that search for the word.

29. An interactive method of searching in accordance with claim 24, which accepts search queries that contain several words and search for each word in separate searches.

30. An interactive method of searching in accordance with claim 24, which accept at least some search queries that contain at least one operator and at least one word and that search for the word and later use the operator to limit the scope of the documents presented to the requestor.

31. An interactive method of searching in accordance with claim 24, which further includes retaining in the knowledge database (200) a record of words previously searched for, the documents captured by such previous searches, and the index terms assigned to the captured documents, and retaining within the knowledge database (200) linkages between the words previously searched for and the documents captured by such previously-conducted searches, such that the search, analysis, and categorizing steps may be bypassed when a word previously searched for is encountered in a later search query.

32. An interactive method of searching in accordance with claim 31, which further includes initially constructing the knowledge database (200) by analyzing indexed documents to which topics have previously been assigned, thereby determining the indexed document's word patterns, and then storing in the knowledge database (200) these word patterns for the indexed documents and the topics assigned to these documents, and then relating the word pattern of an indexed document to the topics assigned to that same indexed document.

33. An interactive method of searching in accordance with claim 31, which further includes maintaining the knowledge database (200) by periodically checking to see if documents entered into the knowledge database (200) have changed or been deleted from the searchable universe of documents; and if they have, then deleting all reference to such documents, as well as the words searched for that caused their capture, from the knowledge database (200), thereby forcing all searches for such words likely to capture such documents to be repeated anew if encountered in a later search query.

34. An interactive method of searching in accordance with claim 31, which further includes maintaining the knowledge database (200) by periodically checking to see if documents entered into the knowledge database (200) have been changed, and if so, reanalyzing and re categorizing such documents and also removing from the knowledge database (200) linkages between such documents and words that they no longer contain.

35. An interactive method of searching in accordance with claim 24, which further includes updating the knowledge database (200) by periodically checking for new documents at some locations within the searchable universe of documents, and analyzing and categorizing such documents prior to those documents being captured by a search.

36. An interactive method of searching in accordance with claim 24, which further includes including in said knowledge database (200) a topic combination table (212) containing replacement topics for certain combinations of other topics that may appear within a captured document, and assigning a replacement topic to such a document as a replacement for said other topics to improve categorization.

37. An interactive method of. searching in accordance with claim 24, which further includes assigning plural topics to at least some documents during categorization, arranging them hierarchically, and linking them to the at least some documents in the knowledge database (200), and presenting to the requester in hierarchical sequence as many lists of topics as there are hierarchical topics associated with the categorized documents, such that the requestor designates multiple topics and subtopics, and such that search precision is improved by eliminating documents irrelevant to the requestor's designated topics from those to which the requester is granted access.

38. An interactive method of searching in accordance with claim 37, which further includes suppressing the presentation of topics to the requester at any given hierarchical level when all the documents are associated with the same topic at that level.

39. An interactive method of searching in accordance with claim 24, which further includes reducing the document data to a list of words; addressing inflection and synonym problems; eliminating non-searchable words; selecting the most frequently occurring words; and selecting frequently-occurring pairings of those words with adjacent words in the document.

40. An interactive method of searching in accordance with claim 39, which further includes selecting up to a predefined number of the most frequently occurring words.

41. An interactive method of searching in accordance with claim 39, which further includes determining whether a word occurs frequently by determining if the number of times the word appears within a document divided by the total word content of the document exceeds a predetermined value.

42. An interactive method of searching in accordance with claim 39, which further includes determining whether a pairing occurs frequently by determining whether the number of occurrences of a given pairing within a given document, divided by the number of occurrences of the adjacent word of the pairing within the document, is greater than a predetermined value.

43. An interactive method of searching in accordance with claim 24, which further includes an arranging for communication with the requestor using the Internet protocol.

44. An interactive method of searching in accordance with claim 43, which further includes maintaining the status of any given search procedure with the requestor.

45. An interactive method of searching in accordance with claim 24, which further includes building into the knowledge database (200) a word table (202), a dictionary (204) and synonyms (206), a topic table (208), a word combination table (210), a topic combination table (212), a query word table (214), a query linkage table (216), and an URL table (218).

46. Computer software program implementing a method according to claim 24 when run on a computing device.

47. An interactive document retrieval system (100) in accordance with claim 1, characterized by
a specially designed user interface (1402) presenting the user an uniform access to all accessible documents, thereby enabling a search in heterogeneous environments, regardless whether they are retrieved from the domain of any corporate networks or from the Internet, and irrespective of their file format.

48. An interactive document retrieval system (100) in accordance with claim 1, characterized by, a specially developed updating function (1312) is employed for visiting Web sites dependent on their individual modification cycles and providing them for a further analysis.

49. An interactive document retrieval system (100) in accordance with claim 1, comprising means for recognizing existing security structures used in the domain of individual companies for securing electronically stored data which enable an integration of said interactive document retrieval system (100) into said security structures without changing them.

50. An interactive document retrieval system (100) in accordance with claim 1, wherein a portability of said interactive document retrieval system (100) into different operating system environments is supported.

51. An interactive document retrieval system (100) in accordance with claim 1, wherein the user is provided with a set of data spaces, each comprising a set of thematically connected documents.

52. An interactive document retrieval system (100) in accordance with claim 1,
wherein a specially designed user interface (1402) comprising presentation programs for generating appropriately formatted texts suitable for the presentation of documents retrieved from the Internet is applied.

53. An interactive document retrieval system (100) in accordance with claim 1, wherein agent programs are applied which continuously process entered search queries in the background.

54. An interactive document retrieval system (100) in accordance with claim 1, wherein each document of a selected category is classified according to its origin, such as public places, media and/or encyclopedias, enterprises or other sources.

55. An interactive document retrieval system (100) in accordance with claim 1, wherein an universally applicable thesaurus with different categories and associated start documents is applied.

56. An interactive document retrieval system (100) in accordance with claim 1, wherein a user interface is applied comprising means for to entering search queries by means of voice commands being automatically recognized and interpreted with the aid of an underlying automatic voice recognition application.

57. An interactive document retrieval system (100) in accordance with claim 1, wherein search results are presented by means of a voice data output.

58. An interactive document retrieval system (100) in accordance with claim 1, wherein a multilingual operation of said interactive document retrieval system (100) is enabled.

59. An interactive method of searching in accordance with claim 24, wherein the user is provided with an uniform access to all accessible documents, thereby enabling a search in heterogeneous environments, regardless whether they are retrieved from the domain of any corporate networks or from the Internet, and irrespective of their file format.

60. An interactive method of searching in accordance with claim 24, wherein predefined exemplary archives are employed comprising the category information for a set of pre-categorized documents in order to save implementation costs which would arise if a new archive structure had to be installed.

61. An interactive method of searching in accordance with claim 24, wherein a specially developed updating function (1312) is employed for visiting Web sites dependent on their individual modification cycles and providing them for a further analysis, thereby guaranteeing a maximum topicality of the employed Internet archive structure.

62. An interactive method of searching in accordance with claim 24, comprising means for recognizing existing security structures used in the domain of individual companies for securing electronically stored data which enable an integration of said interactive document retrieval system (100) into said security structures without changing them.

63. An interactive method of searching in accordance with claim 24, wherein a portability of said interactive document retrieval system (100) into different operating system environments is supported.

64. An interactive method of searching in accordance with claim 24, wherein the user is provided with a set of data spaces, each comprising a set of thematically connected documents.

65. An interactive method of searching in accordance with claim 24, wherein a specially designed user interface (1402) comprising presentation programs for generating appropriately formatted texts suitable for the presentation of documents retrieved from the Internet is applied.

66. An interactive method of searching in accordance with claim 24, wherein agent programs are applied which continuously process entered search queries in the background.

67. An interactive method of searching in accordance with claim 24, wherein each document of a selected category is classified according to its origin, such as public places, media and/or encyclopedias, enterprises or other sources.

68. An interactive method of searching in accordance with claim 24, wherein an universally applicable thesaurus with different categories and associated start documents is applied.

69. An interactive method of searching in accordance with claim 24, wherein a user interface is applied comprising means for to entering search queries by means of voice commands being automatically recognized and interpreted with the aid of an underlying automatic voice recognition application.

70. An interactive method of searching in accordance with claim 24, wherein search results are presented by means of a voice data output.

71. An interactive method of searching in accordance with claim 24, wherein a multilingual operation of said interactive document retrieval system (100) is enabled.

72. A mobile computing and/or telecommunications device, comprising a graphical user interface capable of applying the WAP standard for accessing documents from the Internet and/or any corporate network, characterized by an interactive document retrieval system (100) in accordance with claim 1.

73. An interactive document retrieval system, comprising
a knowledge database (1408) for relating identifications of analyzed documents to topics,
a user interface (1402) for inputting a search query,
a search engine (1406) for searching a resource for documents essentially matching an input search query and for outputting identifications of documents as a search result,
a finding machine (1404) being supplied with the search result of the search engine (1406), for
accessing the knowledge database (1408) to check whether a document identified in the search result has already been analyzed before in relation with other search terms than the present search term,
forwarding the identification of a document along with its related topic as retrieved from the knowledge database (1408) to the user interface (1402) in case the document has already been analyzed before and its identification been stored together with its related topic in the knowledge database (1408), and
analyzing the identified document in case the document has not yet been analyzed before to relate a topic to the identification of the document and forwarding the identification of the document along with its related topic to the user interface (1402).

74. An interactive document retrieval method, the method comprising the steps of
relating (1408) identifications of analyzed documents to topics in a database,
inputting (1402) a search term by means of an user interface,
searching (1406) a resource for documents essentially matching an input search query and outputting identifications of documents as a search result,
accessing the database (1408) to check whether a document identified in the search result has already been analyzed before in relation with other search terms than the present search term,
forwarding the identification of a document along with its related topic as retrieved from the knowledge database (1408) to the user interface (1402) in case the document has already been analyzed before and its identification been stored together with its related topic in the knowledge database (1408), and
analyzing the identified document in case the document has not yet been analyzed before to relate a topic to the identification of the document and forwarding the identification of the document along with its related topic to the user interface (1402).
